(19) United States
(12) Patent Application Publication
(10) Pub. No.: US 2026/0220467 A1
(43) Pub. Date: Jul. 30, 2026

(54) Systems and Methods for Training Neural Networks and Related Machine Learning Models

(71) Applicant: California Institute of Technology, Pasadena, CA (US)

(72) Inventors: Babak Hassibi, San Marino, CA (US); Ali Sahin Lale, Pasadena, CA (US); Gustav Naucler, Pasadena, CA (US)

(73) Assignee: California Institute of Technology, Pasadena, CA (US)

(21) Appl. No.: 19/460,181

(22) Filed: Jan. 26, 2026

Related U.S. Application Data
(60) Provisional application No. 63/749,353, filed on Jan. 24, 2025.

(51) Int. Cl. G06N 3/082; G06N 3/0464; G06N 3/0475

(52) U.S. Cl. CPC G06N 3/082; G06N 3/0464; G06N 3/0475

(57) ABSTRACT

Systems and methods for training-concurrent compression of network models are illustrated. One embodiment includes a method for training-concurrent pruning, performed by processors. The method obtains a pretrained network comprising initial values for a potential function and weights. The method trains a network based upon the pretrained network and training samples, wherein training the network comprises calculating loss for a current network using a loss function; updating a gradient of the potential function at the current time iteration according to a gradient of the loss; updating an inverse mapping of the gradient of the potential function; creating an updated network including updated weights for a next time iteration according to the gradient of the potential function and the inverse mapping of the gradient of the potential function, wherein the updated weights is obtained by pruning the weights of the current network; and storing the updated weights.

### CROSS-REFERENCE TO RELATED APPLICATIONS

The current application claims the benefit of and priority under 35 U.S.C. § 119(e) to U.S. Provisional Patent Application No. 63/749,353, entitled “Systems and Methods for Training Neural Networks and Related Machine Learning Models,” filed Jan. 24, 2025. The disclosure of U.S. Provisional Patent Application No. 63/749,353 is hereby incorporated by reference in its entirety for all purposes.

### FIELD OF THE INVENTION

The present invention generally relates to training neural networks and, more specifically, selecting and using loss and potential functions to train neural networks.

### BACKGROUND

Generative models are systems configured to produce text, images, videos, or other (e.g., media) products based on collections of gathered training data. These models are capable of using deep learning techniques to learn underlying patterns and structures from training data and using these patterns and structures to produce new products. As such, artificial intelligence (AI) systems based on the use of generative models have uses across a wide range of industries, including software development, entertainment, customer service, marketing, art, and design. Development of such systems typically depends on the application of machine learning (e.g., deep learning) techniques in a manner that focuses on the utilization of neural networks to perform tasks such as classification and representation.

Deep learning refers to using artificial neural networks as computational network models for learning representations from training data. These network models are trained utilizing example data points from training sets, and tuning their internal parameters (e.g., weights) so that the model's predictions align well with the given (labels of the) data points. The most important aspect of this process is to learn representations that can be applied to unknown prompts/queries. In doing so, the effectiveness of network models can be measured by efficiency in predicting results based on unseen data points.

### SUMMARY OF THE INVENTION

Systems and methods for training-concurrent compression of neural network models are illustrated. One embodiment includes a method for training-concurrent pruning, performed by one or more processors. The method obtains a pretrained neural network model, wherein the pretrained neural network model comprises initial values for a potential function and a set of weights. The method trains a neural network model based upon the pretrained neural network model and a set of training samples, wherein training the neural network model comprises, for each of a plurality of time iterations: calculating loss for a current neural network model having a current set of weights at a current time iteration using a loss function; updating a gradient of the potential function at the current time iteration according to a gradient of the loss; updating an inverse mapping of the gradient of the potential function; creating an updated neural network model including an updated set of weights for a next time iteration according to the gradient of the potential function and the inverse mapping of the gradient of the potential function, wherein the updated set of weights is obtained by pruning at least a portion of the current set of weights of the current neural network model; and storing the updated set of weights.

In a further embodiment, the trained neural network model is a multi-layered neural network model.

In another embodiment, the multi-layered neural network model is selected from the group consisting of a convolutional neural network model, a recursive neural network model, a multi-layer perceptron, and a generative adversarial network.

In yet another embodiment, the multi-layered neural network model is a large language model.

In still another embodiment, the updated set of weights is further obtained based on at least one additional vector comprising a current set of auxiliary variables for the current neural network model.

In another embodiment, each sample of the set of training samples corresponds to a different auxiliary variable of the current set of auxiliary variables.

In still yet another embodiment, obtaining the updated set of weights for the next time iteration comprises obtaining an updated set of auxiliary variables based on the current set of weights for the current time iteration.

In another embodiment, each auxiliary variable of the current set of auxiliary variables is obtained based on a regularization parameter and the loss function evaluated for the current set of weights at the current time iteration.

In a further embodiment, a regularizer mirror descent (RMD) process is used to obtain at least one selected from the group consisting of the updated set of weights; and the current set of auxiliary variables.

In another embodiment, iterative updates are used to obtain at least one selected from the group consisting of the updated set of weights; and the updated set of auxiliary variables.

In still another embodiment, each of the current set of weights and the current set of auxiliary variables is initialized to at least one selected from the group consisting of: a zero vector and a non-zero vector comprising random numbers within a predetermined threshold of zero.

In yet another embodiment, the loss function comprises a constraint-enforcing loss computed from the current set of auxiliary variables.

In a further embodiment, the constraint-enforcing loss is applied to prevent overfitting the neural network model to the set of training samples.

In another embodiment, a stochastic mirror descent (SMD) process is used to obtain the updated set of weights.

In still another embodiment, the loss function includes a Kurtosis term.

In yet another embodiment, the Kurtosis term is a function of the current set of weights.

In another embodiment, supervised learning is used to train the neural network model.

In a further embodiment, the loss function is configured to only equal zero when a predicted output value of the neural network model exactly matches a labeled output value from the set of training samples.

In still another embodiment, the loss function is selected from the group consisting of a quadratic loss function and a cross-entropy loss function.

In another embodiment, at the current time iteration, obtaining the updated set of weights is based, at least in part, on a learning rate at the current time iteration.

In yet another embodiment, the learning rate is time-invariant.

In a further embodiment, updating the gradient of the potential function at the current time iteration is performed using at least one system selected from the group consisting of Adam, AdamW, AdaGrad, RMSProp, Momentum, and WeightDecay.

In another embodiment, the gradient of the potential function at the current time iteration is obtained recursively based on the gradient of the potential function at a previous time iteration.

In still another embodiment, training the neural network model at the current time iteration further comprises storing the gradient of the potential function at the current time iteration.

In yet another embodiment, after the plurality of time iterations, the potential function is minimized via implicit regularization.

In another embodiment, the potential function is a strictly convex function.

In a further embodiment, the potential function is a norm function.

In still another embodiment, the potential function is selected from the group consisting of: an [symbol] _{q} norm function where q>>1; and an [symbol] _{1+ε} norm function where 1>>ε>0.

In another embodiment, training the neural network model comprises at least one selected from the group consisting of distributed training, batch training, synchronous training, ensemble learning, meta learning, transfer learning, and continual learning.

In yet another embodiment, the inverse mapping of the gradient of the potential function is a many-to-one function.

In a further embodiment, obtaining the updated set of weights bimodally concentrates a distribution of the set of weights.

In another embodiment, quantizing the neural network model after the plurality of time iterations is performed according to a bimodality of the distribution of the set of weights.

In still another embodiment, a data size of each individual weight of the current set of weights is quantized to a single bit.

In yet another embodiment, the potential function is selected to induce sparsity within the set of weights.

In another embodiment, the potential function is selected to induce group sparsity within a trained set of weights for the trained neural network model.

In a further embodiment, the potential function is an elastic net.

One embodiment includes a method for training-concurrent quantization, performed by one or more processors. The method obtains a pretrained neural network model, wherein the pretrained neural network model comprises initial values for a potential function and a set of weights. The method trains a neural network model based upon the pretrained neural network model and a set of training samples, wherein training the neural network model comprises, for each of a plurality of time iterations: calculating loss for a current neural network model having a current set of weights at a current time iteration using a loss function; updating a gradient of the potential function at the current time iteration according to a gradient of the loss; updating an inverse mapping of the gradient of the potential function; creating an updated neural network model including an updated set of weights for a next time iteration according to the gradient of the potential function and the inverse mapping of the gradient of the potential function, wherein creating the updated neural network model bimodally concentrates a distribution of the updated set of weights; and storing the updated set of weights. The method quantizes the trained neural network model after the plurality of time iterations, wherein quantizing the trained neural network model is performed according to a bimodality of the distribution of a trained set of weights.

In a further embodiment, the trained neural network model is a multi-layered neural network model.

In another embodiment, the multi-layered neural network model is selected from the group consisting of a convolutional neural network model, a recursive neural network model, a multi-layer perceptron, and a generative adversarial network.

In yet another embodiment, the multi-layered neural network model is a large language model.

In still another embodiment, the updated set of weights is further obtained based on at least one additional vector comprising a current set of auxiliary variables for the current neural network model.

In another embodiment, each sample of the set of training samples corresponds to a different auxiliary variable of the current set of auxiliary variables.

In still yet another embodiment, obtaining the updated set of weights for the next time iteration comprises obtaining an updated set of auxiliary variables based on the current set of weights for the current time iteration.

In another embodiment, each auxiliary variable of the current set of auxiliary variables is obtained based on a regularization parameter and the loss function evaluated for the current set of weights at the current time iteration.

In a further embodiment, a regularizer mirror descent (RMD) process is used to obtain at least one selected from the group consisting of the updated set of weights; and the current set of auxiliary variables.

In another embodiment, iterative updates are used to obtain at least one selected from the group consisting of the updated set of weights; and the updated set of auxiliary variables.

In still another embodiment, each of the current set of weights and the current set of auxiliary variables is initialized to at least one selected from the group consisting of: a zero vector and a non-zero vector comprising random numbers within a predetermined threshold of zero.

In yet another embodiment, the loss function comprises a constraint-enforcing loss computed from the current set of auxiliary variables.

In a further embodiment, the constraint-enforcing loss is applied to prevent overfitting the neural network model to the set of training samples.

In another embodiment, a stochastic mirror descent (SMD) process is used to obtain the updated set of weights.

In still another embodiment, the loss function includes a Kurtosis term.

In yet another embodiment, the Kurtosis term is a function of the current set of weights.

In another embodiment, supervised learning is used to train the neural network model.

In a further embodiment, the loss function is configured to only equal zero when a predicted output value of the neural network model exactly matches a labeled output value from the set of training samples.

In still another embodiment, the loss function is selected from the group consisting of a quadratic loss function and a cross-entropy loss function.

In another embodiment, at the current time iteration, obtaining the updated set of weights is based, at least in part, on a learning rate at the current time iteration.

In yet another embodiment, the learning rate is time-invariant.

In a further embodiment, updating the gradient of the potential function at the current time iteration is performed using at least one system selected from the group consisting of Adam, AdamW, AdaGrad, RMSProp, Momentum, and WeightDecay.

In another embodiment, the gradient of the potential function at the current time iteration is obtained recursively based on the gradient of the potential function at a previous time iteration.

In still another embodiment, training the neural network model at the current time iteration further comprises storing the gradient of the potential function at the current time iteration.

In yet another embodiment, after the plurality of time iterations, the potential function is minimized via implicit regularization.

In another embodiment, the potential function is a strictly convex function.

In a further embodiment, the potential function is a norm function.

In still another embodiment, the potential function is selected from the group consisting of: an [symbol] _{q} norm function where q>>1; and an [symbol] _{1+ε} norm function where 1>>ε>0.

In another embodiment, training the neural network model comprises at least one selected from the group consisting of distributed training, batch training, synchronous training, ensemble learning, meta learning, transfer learning, and continual learning.

In yet another embodiment, the inverse mapping of the gradient of the potential function is a many-to-one function.

In a further embodiment, a data size of each individual weight of the current set of weights is quantized to a single bit.

In another embodiment, the potential function is selected to enable the bimodality of the distribution of the trained set of weights.

In still another embodiment, the potential function is a rigid cage.

One embodiment includes a non-transitory machine-readable medium storing instructions that, when executed by a processor, are configured to cause the processor to perform operations for training-concurrent pruning. The processor obtains a pretrained neural network model, wherein the pretrained neural network model comprises initial values for a potential function and a set of weights. The processor trains a neural network model based upon the pretrained neural network model and a set of training samples, wherein training the neural network model comprises, for each of a plurality of time iterations: calculating loss for a current neural network model having a current set of weights at a current time iteration using a loss function; updating a gradient of the potential function at the current time iteration according to a gradient of the loss; updating an inverse mapping of the gradient of the potential function; creating an updated neural network model including an updated set of weights for a next time iteration according to the gradient of the potential function and the inverse mapping of the gradient of the potential function, wherein the updated set of weights is obtained by pruning at least a portion of the current set of weights of the current neural network model; and storing the updated set of weights.

In a further embodiment, the trained neural network model is a multi-layered neural network model.

In another embodiment, the multi-layered neural network model is selected from the group consisting of a convolutional neural network model, a recursive neural network model, a multi-layer perceptron, and a generative adversarial network.

In yet another embodiment, the multi-layered neural network model is a large language model.

In still another embodiment, the updated set of weights is further obtained based on at least one additional vector comprising a current set of auxiliary variables for the current neural network model.

In another embodiment, each sample of the set of training samples corresponds to a different auxiliary variable of the current set of auxiliary variables.

In still yet another embodiment, obtaining the updated set of weights for the next time iteration comprises obtaining an updated set of auxiliary variables based on the current set of weights for the current time iteration.

In another embodiment, each auxiliary variable of the current set of auxiliary variables is obtained based on a regularization parameter and the loss function evaluated for the current set of weights at the current time iteration.

In a further embodiment, a regularizer mirror descent (RMD) process is used to obtain at least one selected from the group consisting of the updated set of weights; and the current set of auxiliary variables.

In another embodiment, iterative updates are used to obtain at least one selected from the group consisting of the updated set of weights; and the updated set of auxiliary variables.

In still another embodiment, each of the current set of weights and the current set of auxiliary variables is initialized to at least one selected from the group consisting of: a zero vector and a non-zero vector comprising random numbers within a predetermined threshold of zero.

In yet another embodiment, the loss function comprises a constraint-enforcing loss computed from the current set of auxiliary variables.

In a further embodiment, the constraint-enforcing loss is applied to prevent overfitting the neural network model to the set of training samples.

In another embodiment, a stochastic mirror descent (SMD) process is used to obtain the updated set of weights.

In still another embodiment, the loss function includes a Kurtosis term.

In yet another embodiment, the Kurtosis term is a function of the current set of weights.

In another embodiment, supervised learning is used to train the neural network model.

In a further embodiment, the loss function is configured to only equal zero when a predicted output value of the neural network model exactly matches a labeled output value from the set of training samples.

In still another embodiment, the loss function is selected from the group consisting of a quadratic loss function and a cross-entropy loss function.

In another embodiment, at the current time iteration, obtaining the updated set of weights is based, at least in part, on a learning rate at the current time iteration.

In yet another embodiment, the learning rate is time-invariant.

In a further embodiment, updating the gradient of the potential function at the current time iteration is performed using at least one system selected from the group consisting of Adam, AdamW, AdaGrad, RMSProp, Momentum, and WeightDecay.

In another embodiment, the gradient of the potential function at the current time iteration is obtained recursively based on the gradient of the potential function at a previous time iteration.

In still another embodiment, training the neural network model at the current time iteration further comprises storing the gradient of the potential function at the current time iteration.

In yet another embodiment, after the plurality of time iterations, the potential function is minimized via implicit regularization.

In another embodiment, the potential function is a strictly convex function.

In a further embodiment, the potential function is a norm function.

In still another embodiment, the potential function is selected from the group consisting of: an [symbol] _{q} norm function where q>>1; and an [symbol] _{1+ε} norm function where 1>>ε>0.

In another embodiment, training the neural network model comprises at least one selected from the group consisting of distributed training, batch training, synchronous training, ensemble learning, meta learning, transfer learning, and continual learning.

In yet another embodiment, the inverse mapping of the gradient of the potential function is a many-to-one function.

In a further embodiment, obtaining the updated set of weights bimodally concentrates a distribution of the set of weights.

In another embodiment, quantizing the neural network model after the plurality of time iterations is performed according to a bimodality of the distribution of the set of weights.

In still another embodiment, a data size of each individual weight of the current set of weights is quantized to a single bit.

In yet another embodiment, the potential function is selected to induce sparsity within the set of weights.

In another embodiment, the potential function is selected to induce group sparsity within a trained set of weights for the trained neural network model.

In a further embodiment, the potential function is an elastic net.

One embodiment includes a non-transitory machine-readable medium storing instructions that, when executed by a processor, are configured to cause the processor to perform operations for training-concurrent quantization. The processor obtains a pretrained neural network model, wherein the pretrained neural network model comprises initial values for a potential function and a set of weights. The processor trains a neural network model based upon the pretrained neural network model and a set of training samples, wherein training the neural network model comprises, for each of a plurality of time iterations: calculating loss for a current neural network model having a current set of weights at a current time iteration using a loss function; updating a gradient of the potential function at the current time iteration according to a gradient of the loss; updating an inverse mapping of the gradient of the potential function; creating an updated neural network model including an updated set of weights for a next time iteration according to the gradient of the potential function and the inverse mapping of the gradient of the potential function, wherein creating the updated neural network model bimodally concentrates a distribution of the updated set of weights; and storing the updated set of weights. The processor quantizes the trained neural network model after the plurality of time iterations, wherein quantizing the trained neural network model is performed according to a bimodality of the distribution of a trained set of weights.

In a further embodiment, the trained neural network model is a multi-layered neural network model.

In another embodiment, the multi-layered neural network model is selected from the group consisting of a convolutional neural network model, a recursive neural network model, a multi-layer perceptron, and a generative adversarial network.

In yet another embodiment, the multi-layered neural network model is a large language model.

In still another embodiment, the updated set of weights is further obtained based on at least one additional vector comprising a current set of auxiliary variables for the current neural network model.

In another embodiment, each sample of the set of training samples corresponds to a different auxiliary variable of the current set of auxiliary variables.

In still yet another embodiment, obtaining the updated set of weights for the next time iteration comprises obtaining an updated set of auxiliary variables based on the current set of weights for the current time iteration.

In another embodiment, each auxiliary variable of the current set of auxiliary variables is obtained based on a regularization parameter and the loss function evaluated for the current set of weights at the current time iteration.

In a further embodiment, a regularizer mirror descent (RMD) process is used to obtain at least one selected from the group consisting of the updated set of weights; and the current set of auxiliary variables.

In another embodiment, iterative updates are used to obtain at least one selected from the group consisting of the updated set of weights; and the updated set of auxiliary variables.

In still another embodiment, each of the current set of weights and the current set of auxiliary variables is initialized to at least one selected from the group consisting of: a zero vector and a non-zero vector comprising random numbers within a predetermined threshold of zero.

In yet another embodiment, the loss function comprises a constraint-enforcing loss computed from the current set of auxiliary variables.

In a further embodiment, the constraint-enforcing loss is applied to prevent overfitting the neural network model to the set of training samples.

In another embodiment, a stochastic mirror descent (SMD) process is used to obtain the updated set of weights.

In still another embodiment, the loss function includes a Kurtosis term.

In yet another embodiment, the Kurtosis term is a function of the current set of weights.

In another embodiment, supervised learning is used to train the neural network model.

In a further embodiment, the loss function is configured to only equal zero when a predicted output value of the neural network model exactly matches a labeled output value from the set of training samples.

In still another embodiment, the loss function is selected from the group consisting of a quadratic loss function and a cross-entropy loss function.

In another embodiment, at the current time iteration, obtaining the updated set of weights is based, at least in part, on a learning rate at the current time iteration.

In yet another embodiment, the learning rate is time-invariant.

In a further embodiment, updating the gradient of the potential function at the current time iteration is performed using at least one system selected from the group consisting of Adam, AdamW, AdaGrad, RMSProp, Momentum, and WeightDecay.

In another embodiment, the gradient of the potential function at the current time iteration is obtained recursively based on the gradient of the potential function at a previous time iteration.

In still another embodiment, training the neural network model at the current time iteration further comprises storing the gradient of the potential function at the current time iteration.

In yet another embodiment, after the plurality of time iterations, the potential function is minimized via implicit regularization.

In another embodiment, the potential function is a strictly convex function.

In a further embodiment, the potential function is a norm function.

In still another embodiment, the potential function is selected from the group consisting of: an [symbol] _{q} norm function where q>>1; and an [symbol] _{1+ε} norm function where 1>>ε>0.

In another embodiment, training the neural network model comprises at least one selected from the group consisting of distributed training, batch training, synchronous training, ensemble learning, meta learning, transfer learning, and continual learning.

In yet another embodiment, the inverse mapping of the gradient of the potential function is a many-to-one function.

In a further embodiment, a data size of each individual weight of the current set of weights is quantized to a single bit.

In another embodiment, the potential function is selected to enable the bimodality of the distribution of the trained set of weights.

In still another embodiment, the potential function is a rigid cage.

One embodiment includes a computing system for training-concurrent pruning. The computing system includes a network interface; a memory storing instructions; and one or more processors configured to communicate with the network interface and the memory, the one or more processors further configured to execute the instructions to perform operations. The operations include obtaining a pretrained neural network model, wherein the pretrained neural network model comprises initial values for a potential function and a set of weights. The operations include training a neural network model based upon the pretrained neural network model and a set of training samples, wherein training the neural network model comprises, for each of a plurality of time iterations: calculating loss for a current neural network model having a current set of weights at a current time iteration using a loss function; updating a gradient of the potential function at the current time iteration according to a gradient of the loss; updating an inverse mapping of the gradient of the potential function; creating an updated neural network model including an updated set of weights for a next time iteration according to the gradient of the potential function and the inverse mapping of the gradient of the potential function, wherein the updated set of weights is obtained by pruning at least a portion of the current set of weights of the current neural network model; and storing the updated set of weights.

In a further embodiment, the trained neural network model is a multi-layered neural network model.

In another embodiment, the multi-layered neural network model is selected from the group consisting of a convolutional neural network model, a recursive neural network model, a multi-layer perceptron, and a generative adversarial network.

In yet another embodiment, the multi-layered neural network model is a large language model.

In still another embodiment, the updated set of weights is further obtained based on at least one additional vector comprising a current set of auxiliary variables for the current neural network model.

In another embodiment, each sample of the set of training samples corresponds to a different auxiliary variable of the current set of auxiliary variables.

In still yet another embodiment, obtaining the updated set of weights for the next time iteration comprises obtaining an updated set of auxiliary variables based on the current set of weights for the current time iteration.

In another embodiment, each auxiliary variable of the current set of auxiliary variables is obtained based on a regularization parameter and the loss function evaluated for the current set of weights at the current time iteration.

In a further embodiment, a regularizer mirror descent (RMD) process is used to obtain at least one selected from the group consisting of the updated set of weights; and the current set of auxiliary variables.

In another embodiment, iterative updates are used to obtain at least one selected from the group consisting of the updated set of weights; and the updated set of auxiliary variables.

In still another embodiment, each of the current set of weights and the current set of auxiliary variables is initialized to at least one selected from the group consisting of: a zero vector and a non-zero vector comprising random numbers within a predetermined threshold of zero.

In yet another embodiment, the loss function comprises a constraint-enforcing loss computed from the current set of auxiliary variables.

In a further embodiment, the constraint-enforcing loss is applied to prevent overfitting the neural network model to the set of training samples.

In another embodiment, a stochastic mirror descent (SMD) process is used to obtain the updated set of weights.

In still another embodiment, the loss function includes a Kurtosis term.

In yet another embodiment, the Kurtosis term is a function of the current set of weights.

In another embodiment, supervised learning is used to train the neural network model.

In a further embodiment, the loss function is configured to only equal zero when a predicted output value of the neural network model exactly matches a labeled output value from the set of training samples.

In still another embodiment, the loss function is selected from the group consisting of a quadratic loss function and a cross-entropy loss function.

In another embodiment, at the current time iteration, obtaining the updated set of weights is based, at least in part, on a learning rate at the current time iteration.

In yet another embodiment, the learning rate is time-invariant.

In a further embodiment, updating the gradient of the potential function at the current time iteration is performed using at least one system selected from the group consisting of Adam, AdamW, AdaGrad, RMSProp, Momentum, and WeightDecay.

In another embodiment, the gradient of the potential function at the current time iteration is obtained recursively based on the gradient of the potential function at a previous time iteration.

In still another embodiment, training the neural network model at the current time iteration further comprises storing the gradient of the potential function at the current time iteration.

In yet another embodiment, after the plurality of time iterations, the potential function is minimized via implicit regularization.

In another embodiment, the potential function is a strictly convex function.

In a further embodiment, the potential function is a norm function.

In still another embodiment, the potential function is selected from the group consisting of: an [symbol] _{q} norm function where q>>1; and an [symbol] _{1+ε} norm function where 1>>ε>0.

In another embodiment, training the neural network model comprises at least one selected from the group consisting of distributed training, batch training, synchronous training, ensemble learning, meta learning, transfer learning, and continual learning.

In yet another embodiment, the inverse mapping of the gradient of the potential function is a many-to-one function.

In a further embodiment, obtaining the updated set of weights bimodally concentrates a distribution of the set of weights.

In another embodiment, quantizing the neural network model after the plurality of time iterations is performed according to a bimodality of the distribution of the set of weights.

In still another embodiment, a data size of each individual weight of the current set of weights is quantized to a single bit.

In yet another embodiment, the potential function is selected to induce sparsity within the set of weights.

In another embodiment, the potential function is selected to induce group sparsity within a trained set of weights for the trained neural network model.

In a further embodiment, the potential function is an elastic net.

One embodiment includes a computing system for training-concurrent quantization. The computing system includes a network interface; a memory storing instructions; and one or more processors configured to communicate with the network interface and the memory, the one or more processors further configured to execute the instructions to perform operations. The operations include obtaining a pretrained neural network model, wherein the pretrained neural network model comprises initial values for a potential function and a set of weights. The operations include training a neural network model based upon the pretrained neural network model and a set of training samples, wherein training the neural network model comprises, for each of a plurality of time iterations: calculating loss for a current neural network model having a current set of weights at a current time iteration using a loss function; updating a gradient of the potential function at the current time iteration according to a gradient of the loss; updating an inverse mapping of the gradient of the potential function; creating an updated neural network model including an updated set of weights for a next time iteration according to the gradient of the potential function and the inverse mapping of the gradient of the potential function, wherein creating the updated neural network model bimodally concentrates a distribution of the updated set of weights; and storing the updated set of weights. The operations include quantizing the trained neural network model after the plurality of time iterations, wherein quantizing the trained neural network model is performed according to a bimodality of the distribution of a trained set of weights.

In a further embodiment, the trained neural network model is a multi-layered neural network model.

In another embodiment, the multi-layered neural network model is selected from the group consisting of a convolutional neural network model, a recursive neural network model, a multi-layer perceptron, and a generative adversarial network.

In yet another embodiment, the multi-layered neural network model is a large language model.

In still another embodiment, the updated set of weights is further obtained based on at least one additional vector comprising a current set of auxiliary variables for the current neural network model.

In another embodiment, each sample of the set of training samples corresponds to a different auxiliary variable of the current set of auxiliary variables.

In still yet another embodiment, obtaining the updated set of weights for the next time iteration comprises obtaining an updated set of auxiliary variables based on the current set of weights for the current time iteration.

In another embodiment, each auxiliary variable of the current set of auxiliary variables is obtained based on a regularization parameter and the loss function evaluated for the current set of weights at the current time iteration.

In a further embodiment, a regularizer mirror descent (RMD) process is used to obtain at least one selected from the group consisting of the updated set of weights; and the current set of auxiliary variables.

In another embodiment, iterative updates are used to obtain at least one selected from the group consisting of the updated set of weights; and the updated set of auxiliary variables.

In still another embodiment, each of the current set of weights and the current set of auxiliary variables is initialized to at least one selected from the group consisting of: a zero vector and a non-zero vector comprising random numbers within a predetermined threshold of zero.

In yet another embodiment, the loss function comprises a constraint-enforcing loss computed from the current set of auxiliary variables.

In a further embodiment, the constraint-enforcing loss is applied to prevent overfitting the neural network model to the set of training samples.

In another embodiment, a stochastic mirror descent (SMD) process is used to obtain the updated set of weights.

In still another embodiment, the loss function includes a Kurtosis term.

In yet another embodiment, the Kurtosis term is a function of the current set of weights.

In another embodiment, supervised learning is used to train the neural network model.

In a further embodiment, the loss function is configured to only equal zero when a predicted output value of the neural network model exactly matches a labeled output value from the set of training samples.

In still another embodiment, the loss function is selected from the group consisting of a quadratic loss function and a cross-entropy loss function.

In another embodiment, at the current time iteration, obtaining the updated set of weights is based, at least in part, on a learning rate at the current time iteration.

In yet another embodiment, the learning rate is time-invariant.

In a further embodiment, updating the gradient of the potential function at the current time iteration is performed using at least one system selected from the group consisting of Adam, AdamW, AdaGrad, RMSProp, Momentum, and WeightDecay.

In another embodiment, the gradient of the potential function at the current time iteration is obtained recursively based on the gradient of the potential function at a previous time iteration.

In still another embodiment, training the neural network model at the current time iteration further comprises storing the gradient of the potential function at the current time iteration.

In yet another embodiment, after the plurality of time iterations, the potential function is minimized via implicit regularization.

In another embodiment, the potential function is a strictly convex function.

In a further embodiment, the potential function is a norm function.

In still another embodiment, the potential function is selected from the group consisting of: an [symbol] _{q} norm function where q>>1; and an [symbol] _{1+ε} norm function where 1>>ε>0.

In another embodiment, training the neural network model comprises at least one selected from the group consisting of distributed training, batch training, synchronous training, ensemble learning, meta learning, transfer learning, and continual learning.

In yet another embodiment, the inverse mapping of the gradient of the potential function is a many-to-one function.

In a further embodiment, a data size of each individual weight of the current set of weights is quantized to a single bit.

In another embodiment, the potential function is selected to enable the bimodality of the distribution of the trained set of weights.

In still another embodiment, the potential function is a rigid cage.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 conceptually illustrates an example of a network model configured in accordance with many embodiments of the invention to respond to user queries.

FIG. 2 conceptually illustrates an example of a process for training a model in accordance with an embodiment of the invention.

FIGS. 3A-3C conceptually illustrate processes directed to the quantization of network models.

FIGS. 4A-4B conceptually illustrate processes directed to the pruning of network models.

FIG. 5 illustrates a training-concurrent compression process implemented utilizing mirror descent in accordance an embodiment of the invention.

FIGS. 6A-6B conceptually illustrate histograms of the absolute value of the final weights in a network model for different potentials when trained in accordance with various embodiments of the invention.

FIGS. 7A-7B conceptually illustrate the impact that processes, implemented in accordance with some embodiments of the invention, may have on weight distribution for quantized systems.

FIG. 8 illustrates an example of a training system capable of training models using training-concurrent compression processes implemented in accordance with some embodiments of the invention.

FIG. 9 illustrates an example of a training element capable of executing instructions to perform training-concurrent compression processes that train and/or utilize models in accordance with miscellaneous embodiments of the invention.

FIG. 10 illustrates an example of a training application for training models in accordance with certain embodiments of the invention.

### DETAILED DESCRIPTION

Turning now to the drawings, systems and methods implemented in accordance with numerous embodiments of the invention may be used to simplify deep learning models including but not limited to neural networks and/or machine-learning (ML) models without sacrificing performance. Processes in accordance with a number of embodiments, are used to perform one or more compression processes including but not limited to pruning and quantization concurrently with model training. Models trained using training-concurrent compression processes can incorporate fewer parameters than models trained using conventional processes and/or achieve higher levels of performance compared to other models having similar numbers of parameters. In a number of embodiments, trained models may be deployed to server systems that are capable of generating inferences using the trained models. Training-concurrent compression processes and systems that utilize models trained using such processes (e.g., to generate inferences in response to user requests) in accordance with various embodiments of the invention are discussed further below.

### I. Background

Systems and methods in accordance with many embodiments of the invention may be used to facilitate training of neural networks implemented as structures including but not limited to generative artificial intelligence (“generative AI” or “gen AI”) models. Neural network models incorporated within generative AI systems implemented in accordance with certain embodiments of the invention may include but are not limited to large language models (LLMs) that are trained on large amounts of text data in order to perform natural language processing tasks including but not limited to deciphering, processing, and/or outputting textual phrases. As can readily be appreciated, however, the processes described herein are not limited to use with LLMs and references to LLMs throughout the disclosure should be understood as references to LLMs and/or other state of the art deep learning models. In particular, processes in accordance with several embodiments may be performed by any of a variety of classes of neural network models including (but not limited to) Convolutional Neural Networks (CNNs), Recurrent Neural Networks (RNNs), Multi-Layer Perceptrons (MLPs), and Generative Adversarial Networks (GANs). The specific machine learning model that is utilized in systems implemented in accordance with various embodiments of the invention is typically dependent upon the requirements of a particular application.

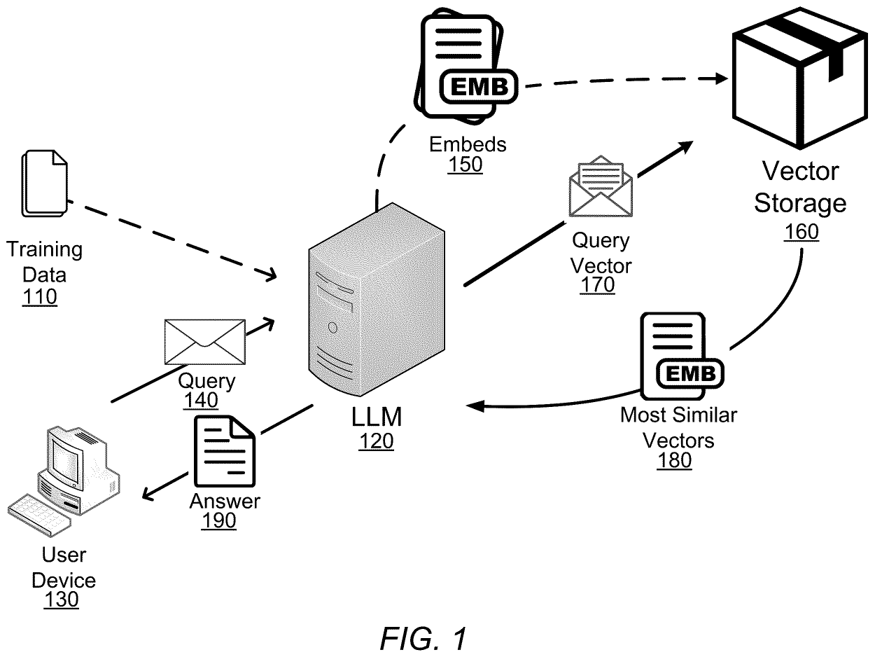

A process for querying a machine learning model trained using a training-concurrent compression process in accordance with an embodiment of the invention is conceptually illustrated in FIG. 1. In the illustrated process, the machine learning model 120 is maintained by systems that receive queries 130 from user devices 140, and returns responses 145. In accordance with many embodiments of the invention queries may be received from users via user interfaces and/or be automated. Processes implemented in accordance with various embodiments of the invention may be used for machine learning (e.g., generative) models including but not limited to LLMs, diffusion models, and/or Hybrid models. Additionally or alternatively, in several embodiments of the invention, machine learning models 120 may be stored through various modes, such as remote storage and/or direct storage. For example, in some embodiments, machine learning models may be stored directly on user devices 140 used for generating (e.g., textual) queries 130. Additionally or alternatively, in certain embodiments, machine learning models 120 may be stored on remote servers accessed through network interfaces. In such cases, the user devices 140 may be configured to send queries 130 to machine learning systems that maintain machine learning models 120 over wired and/or wireless network connections such as Wi-Fi connections, cellular data connections, and/or the Internet.

Upon receiving user queries 130, machine learning system use the queries 130 to search a vector storage 150 for the most similar entries 160. In several embodiments, for example, when the machine learning model 120 is an LLM, the queries 130 may be converted from their original (e.g., textual) forms to vector 170 forms for the search. In various embodiments of the invention, the vector storage 150 may be configured to return (and/or the query vectors 170 may be configured to request) that a certain number of most similar entries 160 be returned to the machine learning system. The most similar entries 160 may have a quantity that is predetermined. In several embodiments, the similarity of the most similar entries 160 may be determined by, but is not limited to, comparing the vectors (e.g., 130, 170) to determine cosine similarity. Once returned, the most similar entries 160 may be converted, by the machine learning system, from vector forms to (e.g., textual) forms for user review. Once done, these (e.g., textual) responses 145 may be returned to the user devices 140.

In accordance with many embodiments of the invention, machine learning models 120 may be trained based on training data 190 (and/or samples). The training data 110 implemented may include (but is not limited to) video, audio, text, images, etc. In various embodiments, training data 190 may include labels (e.g., in the form of scalars) classifying the substantive input training data. Training data 190 in accordance with some embodiments of the invention can be received continuously by the machine learning system, where the network model(s) 120 may be continuously updated as new training data 190 is received. Based on the training data 190, the machine learning model 120 may convert the training data 190 into embeddings 180 and/or feature vectors that (e.g., numerically) represent the underlying information (classifications). In several embodiments of the invention, the embeddings 180 may be kept in vector storage 150. In some cases, the vector storage 150 may be kept but is not limited to user devices 140 (e.g., where the machine learning model 120 is stored) and/or remote servers (e.g., that may be stored along with the machine learning model 120). Training in accordance with numerous embodiments of the invention can result in models that are capable of generalizations to new unseen samples, as is expanded upon below.

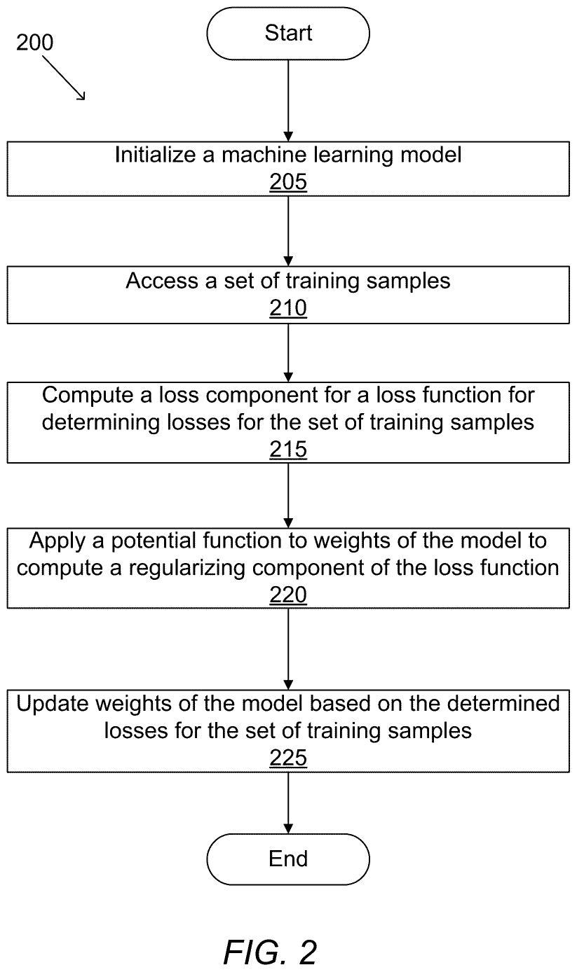

An example of a training-concurrent compression process for training a machine learning model in accordance with an embodiment of the invention is illustrated in FIG. 2. In a variety of embodiments, processes can be performed in parallel, across multiple processors and/or computers. Process 200 initializes (205) a machine learning model. Machine learning models in accordance with numerous embodiments of the invention can include (but are not limited to) neural networks, such as CNNs/ANNs, linear models, etc. In several embodiments, initializing a model can include pre-training the model on a first set of data, where the training process can use a different second set of data for transfer learning. Initializing the model in accordance with various embodiments of the invention can include pre-training the model to have loss at or under a given threshold (e.g., 0). As can readily be appreciated, the use of a pre-training process and/or the specific pre-training process utilized (if at all) is largely dependent upon the requirements of a given application.

Process 200 accesses (210) a set of training samples. Training samples in accordance with several embodiments of the invention can include labeled data. In some embodiments, training samples can include various data types (and/or accompanying labels), such as, but not limited to, images, video, text, numeric data, etc. In many embodiments, the set of training samples can be applied to training the model concurrently with the process 200.

Process 200 computes (215) a loss component for a loss function that calculates losses for the set of training samples. As discussed above, in some embodiments, the model may be a neural network undergoing supervised learning or unsupervised learning. In the former case, the loss component may be configured to measure the differences between a labeled value for one or more training samples and the predicted values for the samples. In many embodiments, loss components can include a constraint-enforcing loss. Constraint-enforcing losses in accordance with several embodiments of the invention can be used to prevent overfitting of the model to the training samples. In many embodiments, constraint-enforcing losses can be computed from a set of auxiliary variables, that may refer to (e.g., neural network) parameters. Additionally or alternatively, in various cases, each sample may have at least one associated auxiliary variable. Auxiliary variables in accordance with many embodiments of the invention can be updated based on a gradient of the constraint-enforcing loss computed for one or more training samples. In several embodiments, auxiliary variables can be initialized to 0 and/or to random values (near-zero). When auxiliary variables are random values initialized to near-zero, they may be initialized using a random number generator (e.g., within a pre-determined threshold of zero).

Process 200 applies (220) a potential function to weights of the model to compute a regularizing component of the loss function. Potential functions (“potentials”) in accordance with a variety of embodiments of the invention can include various q-norm potentials, where q is a number (e.g., 1, 2, 3, 10, etc.), and/or a negative entropy potential. In certain embodiments, processes can select potential functions to achieve certain objectives (e.g., [symbol] ₁ norms to promote sparsity, [symbol] ₁₀ norms to promote generalization, etc.). Regularizing components in accordance with certain embodiments of the invention can be selected to optimize closeness to the initialized model, where closeness can be computed as a Bregman divergence.

Process 200 updates (225) weights of the model based on the determined losses for the set of training samples. Although this process is described as a single iteration, one skilled in the art will recognize that similar systems and methods will generally be used as part of an ongoing optimization process. In a number of embodiments, optimizations can be performed with weighted values to emphasize the loss or regularizing components of the loss function. Processes in accordance with many embodiments of the invention can weight the loss component for an overparameterized model such that the loss is forced to 0, where the process further optimizes the regularizing component.

While specific processes for training a model are described above, any of a variety of processes can be utilized to train models as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. In addition, models trained in accordance with the methods described above with reference to FIG. 2 can be utilized in any of the systems described herein.

In implementing the above systems, potential functions and/or constraint-enforcing losses may be used to facilitate the training of the deep learning models. The alignment of a model and a data point i can be measured by a (non-negative) “loss function” Lᵢ(w) (or [symbol] ( [symbol] )) for any weight vector w. For a training set consisting of n data points, the total loss can be calculated as

$${\sum }_{i = 1}^{n} {L}_{i} ( w ) ,$$

which can then be minimized (e.g., using processes in accordance with many embodiments of the invention. In many cases, minimization is typically done using an algorithm called stochastic gradient descent (SGD) (or its variants, such as distributed, mini-batch, adaptive, and momentum). Denoting the model parameters at the t-th time step by wₜ, and the instantaneous loss function corresponding to the i-th sample by Lᵢ(·), the update rule of SGD is defined as wₜ=wₜ₋₁−η∇Lᵢ(wₜ₋₁), t≥1, where n is a hyper-parameter known as the “step size” or the “learning rate,” w₀ is the initialization, and ∇Lᵢ(·) is the gradient of the loss (usually computed using an approach known as “backpropagation”). This procedure can be repeated many times until some stopping criterion is met. As can readily be appreciated SGD is simply one approach to minimizing a total loss calculation and the specific total loss function and minimization algorithm that is utilized is largely dependent upon the requirements of specific applications.

Deep learning neural network models directed to purposes including but not limited to natural language processing tasks (e.g., LLMs) can have as many as several trillion parameters. The memory, computing, storage, and communication costs required for models of this size can make deep learning models both exceedingly expensive (both financially and temporally) and especially difficult to personalize and/or integrate into low-latency/real-time applications. Systems may address expenses associated with these amounts of parameters through simplification processes including but not limited to (data) compression. The effects of the above simplifications can include saving memory and speeding up inference speed. As such, the term compression is used herein to describe any processes directed to the objective of reducing the memory (and/or processing power) associated with running machine learning models. As such, i accordance with many embodiments of the invention, compression processes may involve but are not limited to network quantization (i.e., representing weights and activations of an existing network with lower bit precision) and network pruning (i.e., removing parameters from an existing network). Many embodiments of the invention are able to achieve significant compression with minimal impact on model performance by using one or more of the various training-concurrent compression processes described below.

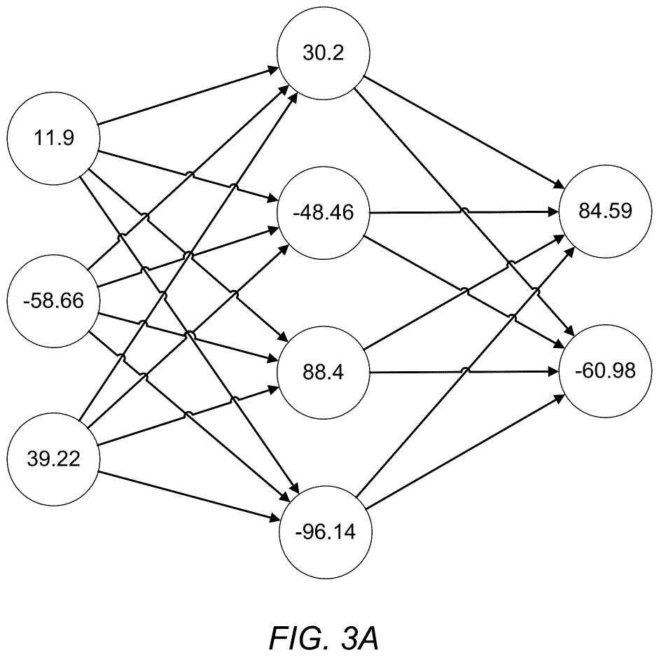

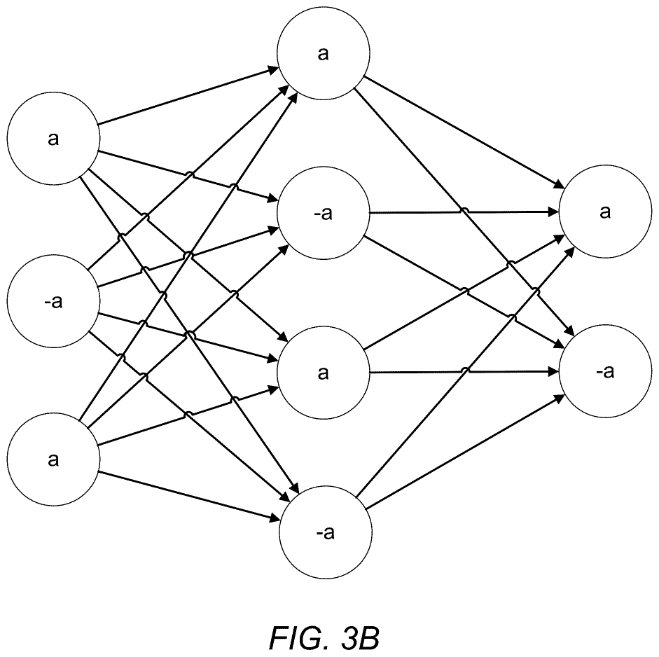

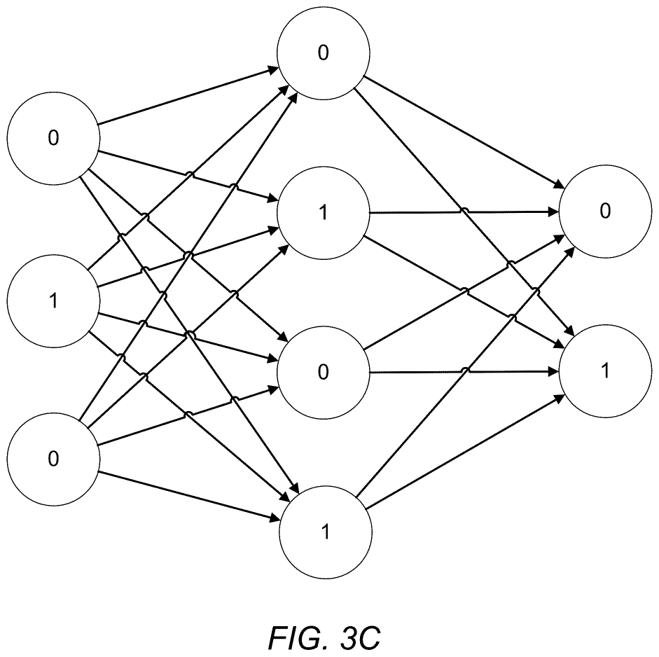

An example of the quantization of a neural network is illustrated in FIGS. 3A-3C. Quantization may refer to the process of reducing the precision of (and memory requirements associated with) network parameters including but not limited to weights, biases, and/or activations such that the quantized network parameters occupy less memory. Most commonly, quantization involves reducing 32-bit or 16-bit binary representations of floating point values (e.g., the example disclosed in the various weights of FIG. 3A) to smaller representations in the form of 8-bit binary representations of integer values. Nevertheless, conventional quantization processes generally involve quantizing fully-trained networks, which carries the possibility of cascading effects where quantization of especially salient parameters (i.e., parameters for which the model output is especially sensitive) significantly impact the efficiency and/or efficacy of the neural network.

Systems and methods in accordance with many embodiments of the invention perform training-concurrent quantization processes that quantize parameters to a single bit representation, which can be referred to as a one-bit quantization process in this disclosure. As suggested above, one-bit quantization in multi-layered neural networks, e.g., convolutional neural networks (CNNs), recursive neural networks (RNNs), and LLMs, can provide significant memory storage and computation benefits. In such networks, at each layer, the output of the activation functions may be “weighted” by the model parameters and summed to form the inputs to the activation functions in the next layer. When the parameters are floating point numbers, this “weighting” is performed using multiplication operations. When the weights are binary (single bit) multiplication is unnecessary and the necessary operations may be implemented using addition and subtraction operations. In accordance with various embodiments of the invention, one-bit quantization of a neural network model may be achieved through quantizing the models as the model is trained. Specifically, one-bit quantization may be performed by starting with a large network model and simultaneously learning from the training data while guiding the weights towards a distribution that is much more amenable to quantization. As shown in FIG. 3B, the weights are updated in such a way that the values of the parameters in each layer concentrate to one of two values: +a and −a. This makes quantization to one-bit straightforward binary reduction—the weights concentrated around +a are quantized to “1,” and the weights concentrated around −a to “0,” as illustrated in FIG. 3C.

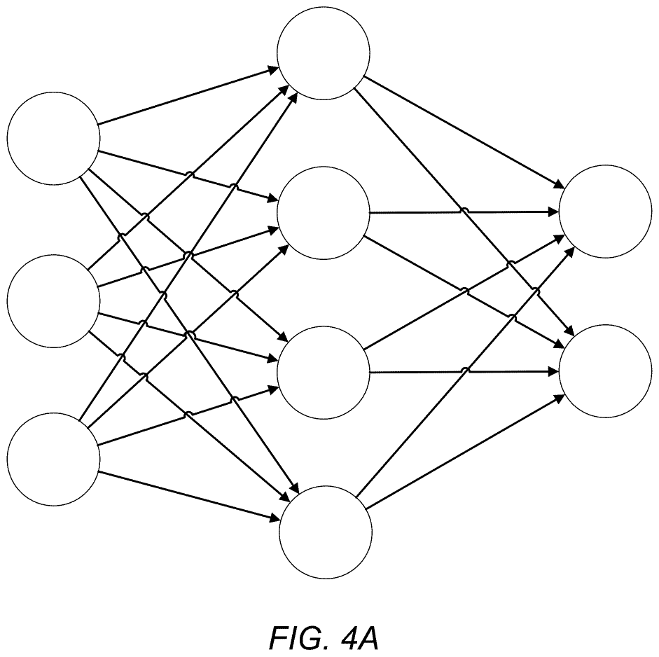

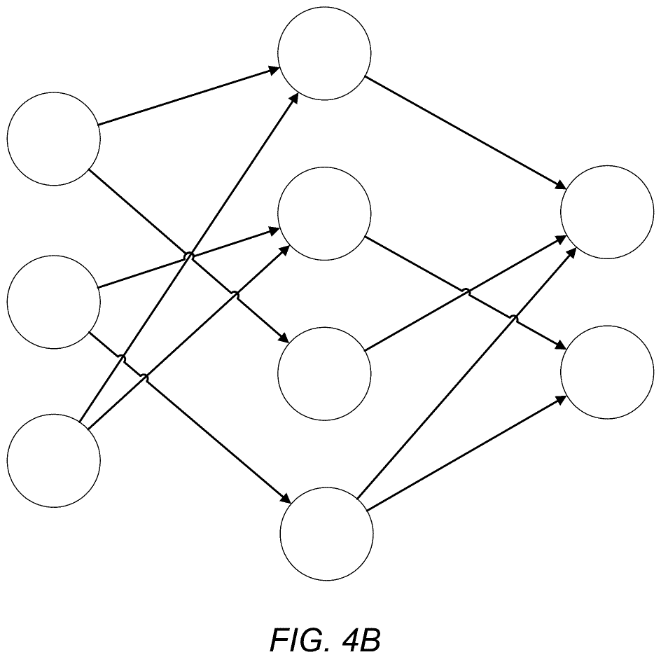

An example of the pruning of network models is illustrated in FIGS. 4A-4B. Pruning may refer to the process of removing redundant network parameters including but not limited to weights, biases, and/or activations from neural networks as a form of compression. Most commonly, pruning may be used to combat overfitting and improve generalization capabilities. As is the case for quantization, the salience of particular network parameters may be evaluated before determining whether they should be pruned. Many implementations of pruning employ some second-order information about the error landscape for this purpose, an approach which can be very costly to implement and often does not scale to large models (in particular, LLMs) due to similar cascading effects that can occur during conventional quantization processes. Therefore, systems in accordance with various embodiments of the invention may be used to facilitate network pruning in tandem with learning to produce systems that are more amenable to large-scale operation. By doing so, pruning may be used to reduce the size of over-parametrized networks without sacrificing too much performance. Systems and methods in accordance with various embodiments may, additionally or alternatively, monitor the performance (or training efficacy) of networks undergoing pruning. In such cases, systems may be configured to cease pruning beyond a threshold during the training process.

As described above, systems and methods in accordance with many embodiments may prune networks as they train, starting with a large network model and simultaneously learning from the training data while removing weights that are redundant and/or unnecessary. By doing so, resulting neural networks will have been pruned to find a set of weights that performs well on the training data while being sparse. This is illustrated in FIGS. 3A and 3B of the filed application, where FIG. 3A shows a fully connected neural network with all weight connections intact between layers, and FIG. 3B shows the same network architecture after pruning where certain connections (weights) have been removed, resulting in a sparser network structure with fewer parameters while maintaining the essential connectivity needed for the model to function.

Applications and methods in accordance with various embodiments of the invention are not limited to neural networks. Accordingly, it should be appreciated that the data compression processed described herein can also be implemented with various model configurations in accordance with the invention. Various systems and methods for implementing training-concurrent compression processes in accordance with some embodiments of the invention are discussed further below.

Systems in accordance with many embodiments of the invention may use learning to facilitate decision-making processes. Supervised learning uses (labeled) training data to build mapping functions that associate new data with expected output values for purposes including but not limited to pattern recognition and/or prediction. As such, in accordance with some embodiments of the invention (e.g., supervised) learning may use training data sets

$${\{ {x}_{i} , {y}_{i} \}}_{i = 1}^{n} ,$$

where n represents the size of the training set; xᵢ∈ [symbol] ^{d}^{ᵢₙ} represents the feature vector (i.e., input); dᵢₙ represents the dimension of the feature(s) (e.g., the number of pixels in image input; the context length in text input); yᵢ∈ [symbol] ^{d}^{ₒᵤₜ} represents the corresponding label (i.e., output); and dₒᵤₜ represents the dimension of the label (e.g., the context length in label text). In some embodiments of the invention, labels may be scalars (i.e., dₒᵤₜ=1).

Network models implemented in accordance with many embodiments of the invention may map variables including but not limited to the feature vectors xᵢ; weight vectors w∈ [symbol] ^{p} (where p represents the size of the weight vector, i.e., the number of parameters in the model); and/or various input-associated variables to the labels yᵢ via a function ƒ( [symbol] ). In accordance with many embodiments of the invention, the number of parameters p well exceeds the size of the training data n, i.e., p>n (over-parametrization). In such cases, network models may perfectly interpolate (learn) the training data, determining that there exists at least one optimal weight vector w, such that:

$$f ( {x}_{i} , w ) = {y}_{i} , i = 1 , 2 , … , n . \qquad ( 1 )$$

In fact, the set of weight vectors w that interpolate the data may form a p-n dimensional manifold which, when p»n, becomes very high-dimensional. Systems and methods in accordance with certain embodiments of the invention may exploit the high-dimensional interpolating manifold(s) to find solutions that is simultaneously interpolating and primed for compression. Specifically, by training in mirrored domains and/or utilizing (constraint-enforcing) losses, processes in accordance with some embodiments of the invention can train models to achieve various objectives, such as (but not limited to) sparseness and/or generalization. Processes in accordance with various embodiments of the invention can therefore be used for training networks in various settings including, but not limited to: distributed learning, (mini) batch learning, (a) synchronous learning, ensemble learning, meta learning, transfer learning, and continual learning (and/or learning with features including but not limited to adaptive learning rates, momentum, and/or early stopping).

### II. Mirror Descent Algorithms

Systems and methods in accordance with various embodiments of the invention can improve optimization processes significantly through implementing mirror descent algorithms.

### A. Background

Systems and methods in accordance with various embodiments can train neural networks by solving various optimization problems. Systems can, in some cases, augment a loss function with a term that promotes closeness to the initial weights w₀ and train the neural networks by solving the following optimization problem:

$${min}_{w} λ {\sum }_{i = 1}^{n} {L}_{i} ( w ) + {D}_{ψ} ( w , {w}_{0} ) , \qquad ( 2 )$$

where D_{ψ}( [symbol] ) is the Bregman divergence corresponding to a differentiable strictly-convex function ψ: [symbol] ^{p}→ [symbol] , referred to as the “potential function.” For example, when

$$ψ ( w ) = \frac{1}{2} {‖ w ‖}^{2} ,$$

the Bregman divergence is just the usual Euclidean distance, i.e.,

$${D}_{ψ} ( w , {w}_{0} ) = \frac{1}{2} ‖ w - {w}_{0} {‖}^{2} .$$

Other examples of potential functions in accordance with several embodiments of the invention are discussed in greater detail below. In certain embodiments, models can be “warm-started” with an initialization weight w₀, e.g., for transfer learning. In some such cases, a parameter 1 can determine how much weight one wants to give to the loss versus a “regularizer” (where the bigger 2 is, the more effort is spent on minimizing the loss). In scenarios where a particularly good initialization w₀ is not known, and/or where it is desirable to regularize the weights in an absolute sense, systems in accordance with some embodiments can choose w₀ to be the minimizer of ψ(·) (e.g., 0 for

$$ψ ( w ) = \frac{1}{2} {‖ w ‖}^{2}$$

and other potential functions). In this case, the optimization problem (2) can be reduced to the following special case:

$${min}_{w} λ {\sum }_{i = 1}^{n} {L}_{i} ( w ) + ψ ( w ) . \qquad ( 3 )$$

Typical deep neural networks can often have a lot of capacity (i.e., a large number of parameters), which allows them to fit the training data to zero error (i.e.,

$${\sum }_{i = 1}^{n} {L}_{i} ( w ) \approx 0 ) .$$

However, for various reasons, e.g., when a training data set includes corrupted samples, it may be desirable to avoid fitting the training data all the way to zero error/loss. That is part of the reason the above formulations can be beneficial in many applications.

In many embodiments, auxiliary variables can be used to avoid fitting data to zero error/loss. Defining an auxiliary variable z∈ [symbol] ⁿ with elements z(i) for i=1, . . . , n, optimization problem (2) can be transformed into the following form:

$${min}_{w , z} λ {\sum }_{i = 1}^{n} \frac{{z}^{2} ( i )}{2} + {D}_{ψ} ( w , {w}_{0} ) s . t . z ( i ) = \sqrt{2 {L}_{i} ( w )} , i = 1 , … , n . \qquad ( 4 )$$

The objective of this optimization problem is a Bregman divergence, i.e.,

$${D}_{ϕ} ( [ \begin{matrix}w \\ z\end{matrix} ] , [ \begin{matrix}{w}_{0} \\ \vec{0}\end{matrix} ] ) ,$$

where

$$ϕ ( [ \begin{matrix}w \\ z\end{matrix} ] ) = ψ ( w ) + \frac{λ}{2} {‖ z ‖}^{2} .$$

Because the objective is a Bregman divergence, and there are n equality constraints, processes in accordance with a variety of embodiments of the invention can derive (mirror descent) algorithms for solving them, as described in greater detail below. In many embodiments, in order to enforce the constraints z(i)=\sqrt{2Lᵢ(w)}, a “constraint-enforcing” loss can be defined as [symbol] (z(i)−\sqrt{2Lᵢ(w)}, where [symbol] (·) is a differentiable and convex function with a unique root at 0 (an example is

$$ℓ ( \cdot ) = \frac{{( \cdot )}^{2}}{2} ) .$$

In several embodiments of the invention, at time t, when the i-th training sample is chosen for updating the model, the following update is performed:

$$∇ ψ ( {w}_{t} ) = ∇ ψ ( {w}_{t - 1} ) + \frac{η {ℓ}^{′} ( {z}_{t - 1} ( i ) - \sqrt{2 {L}_{i} ( {w}_{t - 1} )} )}{\sqrt{2 {L}_{i} ( {w}_{t - 1} )}} ∇ {L}_{i} ( {w}_{t - 1} ) , {z}_{t} ( i ) = {z}_{t - 1} ( i ) - \frac{η {ℓ}^{′} ( {z}_{t - 1} ( i ) - \sqrt{2 {L}_{i} ( {w}_{t - 1} )} )}{λ} , {z}_{t} ( j ) = {z}_{t - 1} ( i ) , ∀ j \neq i , \qquad ( 5 )$$

where ∇ψ(·) is the gradient of the potential function, and [symbol] ′(·) is the derivative of the constraint-enforcing loss function. The variables can be initialized with w₀ and z₀=0 (or something close to 0). In accordance with many embodiments, in cases where, due to practical considerations, weights and/or the auxiliary variables cannot be initialized at zero, they can be initialized randomly at some small values (e.g., within a certain threshold of zero) without impacting performance. Note that because of strict convexity of the potential function ψ(·), its gradient ∇ψ(·) is invertible, and the above update rule is well-defined. This iterative process can solve the optimization problem (2) (and the optimization problem (3) when w₀=0). y parameter

### B. Stochastic Mirror Descent and Regularizer Mirror Descent

Mirror descent algorithms including but not limited to stochastic mirror descent (SMD) and regularizer mirror descent (RMD) algorithms may be used to simultaneously learn and prime neural networks configured in accordance with various embodiments of the invention for compression during the training process. In doing so, systems may (e.g., continuously update values for weights and/or auxiliary variables. These algorithms may operate based on functions including but not limited to the (strictly convex) potential function, ψ(·), of the weight vector w∈ [symbol] ^{p}, where p is the number of parameters in the network; and/or loss functions [symbol] ( [symbol] ). As can be readily appreciated, the specific functions that are utilized in an SMD and/or RMD algorithm are largely dependent upon the nature of the network being optimized and/or the requirements of specific applications.

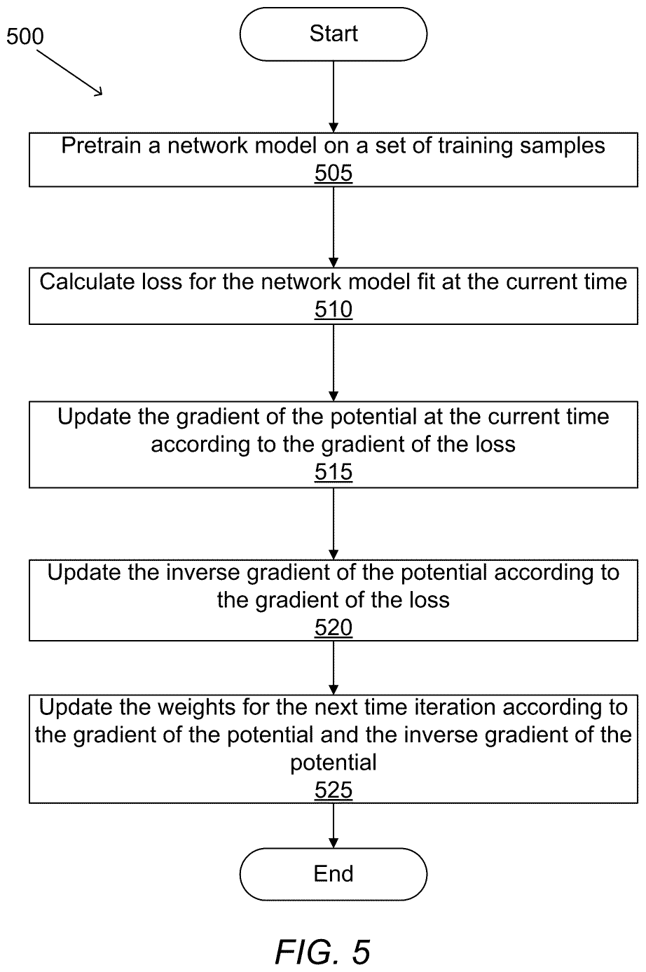

A process for training-concurrent compression, implemented utilizing mirror descent in accordance with some embodiments of the invention is illustrated in FIG. 5. Process 500 pretrains (505) a network model on a set of training samples. Models in accordance with numerous embodiments of the invention can include (but are not limited to) neural networks, linear models, etc. In several cases, pretraining (505) may include steps for determining initial values for weights (i.e., w₀) and/or auxiliary variables (i.e., z(0)) Pretraining (505) the network model can involve, but is not limited to using datasets (including but not limited to the training dataset incorporating the set of training samples) for transfer and/or supervised learning. Meanwhile, training samples in accordance with several embodiments of the invention can include labeled data. In miscellaneous embodiments, training samples can include various types of data and/or labels, such as (but not limited to) images, video, text, numeric data, etc.

Process 500 calculates (510) loss for the network model at the current time iteration using a loss function. Examples of loss functions implemented in accordance with several embodiments of the invention may include but are not limited to quadratic loss and cross-entropy loss. In accordance with various embodiments of the invention, loss functions [symbol] ( [symbol] ) may be configured such that, when a predicted output value exactly matches a labeled value, the loss is determined to be zero (i.e., [symbol] (a, b)=0, iff a=b). As can readily be appreciated, the specific loss function that is utilized is largely dependent upon the requirements of specific applications.

Process 500 updates (515) the gradient of the potential function (of the network model) at the current time iteration according to a gradient of the loss. Potential functions in accordance with numerous embodiments of the invention may include but are not limited to (e.g., strictly) convex functions. Additionally or alternatively, potential functions can include various q-norm potentials, where q is a number (e.g., 1, 2, 3, 10, etc.), and where the various values for q correspond to different process 500 objectives including but not limited to types of data compression.

Process 500 updates (520) the inverse gradient of the potential according to the gradient of the loss. The gradient of the potential vector can be viewed as a mapping from the weight space of w to the gradient space (the mirror domain). As such, in accordance with various embodiments of the invention, for each iteration (t), SMD can operate under the assumption that the gradient of the potential function would be updated along the negative direction of the loss function to train the model. In various embodiments of the invention, updating the inverse gradient may be done based on parameters including but not limited to (e.g., time-varying) step size (e.g., based upon learning rate). Process 500 updates (525) the weights for the next time iteration according to the gradient of the potential and the inverse gradient of the potential. In accordance with many embodiments of the invention, the updated weights may be used for data compression purposes. As suggested above, when the form of data compression corresponds to a pruning process, each update (525) to the weights may involve a specific pruning step. Additionally or alternatively, when the form of data compression corresponds to a quantizing process, each update (525) to the weights may be directed to producing a final bimodal weight vector that can subsequently be used for (e.g., one-bit) quantization.

While specific training-concurrent processes for updating model weights using mirror descent are described above, any of a variety of processes can be utilized to train models as appropriate to the requirements of specific applications in accordance with various embodiments of the invention. In several embodiments, steps may be executed or performed in any order or sequence not limited to the order and sequence shown and described. In numerous embodiments, some of the above steps may be executed or performed substantially simultaneously where appropriate or in parallel to reduce latency and processing times. In multiple embodiments, one or more of the above steps may be omitted. Furthermore, the training concurrent processes are not limited to the specific loss and/or potential functions described above and can utilize any loss and/or potential function appropriate to the requirements of specific applications.

a. SMD Process for Compression

In accordance with many embodiments of the invention, SMD may facilitate model compression alongside model learning using systems implemented to update the gradient of the potential vector with respect to the (current) weight vector. SMD may therefore update the gradient of the potential, ∇ψ(w(t)), along the negative direction of the loss function with respect to the model parameters. In several embodiments of the invention, this update can operate according to the following equation:

$$∇ ψ ( w ( t + 1 ) ) = ∇ ψ ( w ( t ) ) - η ( t ) ∇ ℓ ( f ( x ( t ) , w ( t ) ) , y ( t ) ) , w ( 0 ) \qquad ( 6 )$$

where t is the iteration, w(t) is the weight at iteration t, and (x(t), y(t)) is the training point used at iteration t. In this equation, ∇ represents the gradient with respect to the weight vector, so that ∇ψ(·) and ∇ [symbol] ( [symbol] ) are the gradients of the potential and loss functions, respectively (e.g., with respect to the weight vector). η(t)>0 is the learning rate at iteration t. It may be time-varying or time-invariant, i.e., η(t)=η. Finally, w(0) is the value, to which that the weight vector is initialized. In accordance with many embodiments of the invention, gradient update term(s) the (e.g. η(t)∇ [symbol] (ƒ(x(t),w(t),y(t))) may be replaced by variations, including but not limited to (ones based on) Adam, AdamW, AdaGrad, RMSProp, Momentum, WeightDecay, etc. As can readily be appreciated, the specific manner in which the gradient update terms are calculated is largely dependent upon the requirements of specific applications.

Among all solutions that interpolate the training data, SMD may be used to converge on one or more solutions that minimize the potential ψ(·). As mentioned earlier, in the over-parametrized scenarios, there are infinitely many weight vectors that satisfy the interpolating conditions. In accordance with many embodiments of the invention, when initialized by w(0)=w₀, after convergence, SMD may find an interpolating solution that satisfies:

$${min}_{w such that ( {x}_{i} , w ) = {y}_{i} , i = 1 , 2 , … , n} ψ ( w ) - ∇ {ψ ( {w}_{0} )}^{T} ( w - {w}_{0} ) . \qquad ( 7 )$$

As mentioned above, for overparameterized linear models, SMD can converge to the closest global minimum to the initialization point(s). For initialization points around “zero” (i.e., the minimizer of the potential), the closest global minimum to the initialization point may mean convergence to the minimum-potential interpolating solution. Specifically, when w₀ is initialized as the minimizer of ψ, so that ∇ψ(w₀)=0, after convergence, SMD may find a solution that satisfies:

$${min}_{w such that ( {x}_{i} , w ) = {y}_{i} , i = 1 , 2 , … , n} ψ ( w ) \qquad ( 8 )$$

a process known as implicit regularization.

Since the learning algorithm is a function of the updated weights, an inversion (depending on an inverse mapping of the gradient of the potential: ∇⁻¹ψ(·)) may be calculated for the actual process of updating the weights based on equation (6). This may be implemented in at least two variations: a one-step process with a lower memory requirement, but potentially lower numerical stability/consistency; and a two-step process with a high memory requirement, but higher numerical stability.

The one-step process for updating weights may operate based on computing both the gradient of the potential and the inverse gradient of the potential at each iteration. In various embodiments, for a given time step, updates to the weights may similarly be based on, but are not limited to:
estimates for the (current) gradient of the potential (i.e., ∇ψ(w(t)));
training inputs (i.e., x(t));
corresponding training output values (i.e., y(t));
(current) weight values (i.e., w(t));
predicted output values based on the training inputs/weights (i.e., ƒ (x(t), w(t)));
loss gradients, based on the loss computed between the predicted output values and the training output values (i.e., ∇ [symbol] (ƒ(x(t),w(t)),y(t))); and
learning rates (i.e., η(t))
   For example, one estimate for future weights may effectively follow the following:

$$w ( t + 1 ) = {∇}^{- 1} ψ [ ∇ ψ ( w ( t ) ) - η ( t ) ∇ ℓ ( f ( x ( t ) , w ( t ) ) , y ( t ) ) ] , w ( 0 ) . \qquad ( 9 )$$

The one-step update (9) has the advantage that one needs only store the weight estimate w(t) at each time iteration. In some cases, these operations may be numerically ill-conditioned which, as mentioned, can affect the numerical stability of the method.

The two-step method may alleviate the aforementioned numerical instability by computing the gradient of the potential at the point of initialization ∇ψ(w(0)) and continuously/recursively deriving and storing estimates for the gradient of the potential (at later time iterations) based on that initial estimate. These estimates for the future gradient of the potential may, in turn, be used to update the weights. In some embodiments, for a given time step, estimates for the future gradient of the potential may similarly be based on, but is not limited to: estimates for the (current) gradient of the potential; training inputs; corresponding training output values; (current) weight values; predicted output values based on the training inputs/weights; loss gradients, based on the loss computed between the predicted output values and the training output values; and learning rates. That said, in some cases, when the estimates for the gradient of the potential is defined as ξ(t)=∇ψ(w(t)) the process at each iteration may be approximated as:

$$\{ \begin{matrix}ξ ( t + 1 ) = ξ ( t ) - η ( t ) ∇ ℓ ( f ( x ( t ) , w ( t ) ) , y ( t ) ) , ξ ( 0 ) = ∇ ψ ( w ( 0 ) ) \\ w ( t + 1 ) = {∇}^{- 1} ψ [ ξ ( t + 1 ) ]\end{matrix} \qquad ( 10 )$$

The two-step method can substantially alleviate numerical instability since it only requires computing inverse ∇⁻¹ψ(·) at each iteration. The price for this is that the memory requirement doubles: systems will need to store both ξ(t) and w(t).
b. RMD Process for Compression

Additionally or alternatively, systems configured in accordance with some embodiments of the invention may facilitate model learning using RMD to update the gradient of the potential vector with respect to other vectors (i.e., auxiliary variables). In such embodiments, in addition (or alternative) to updating the weights w(t) in the mirror domain, systems may update a set of n auxiliary variables zᵢ(t). In some cases, the weights may be interpreted as just another variation on the auxiliary variables, being updated in a comparable manner. For example, each of these auxiliary variables may themselves correspond to particular element(s) of the training set

$${\{ {x}_{i} , {y}_{i} \}}_{i = 1}^{n} .$$

$${z}_{i} ( t + 1 ) = \{ \begin{matrix}{z}_{i} ( t ) - \frac{λ}{n} η ( t ) ( {z}_{i} ( t ) - \sqrt{ℓ ( f ( {x}_{i ( t )} , w ( t ) ) , {y}_{i ( t )} )} ) & if i = i ( t ) \\ {z}_{i} ( t ) & otherwise\end{matrix} \qquad ( 11 )$$

Here i(t) may refer to the index of the training element that is being used for the gradient updates at time t; and λ>0 may refer to a regularization parameter.

As above, for each time step/iteration (t), RMD can operate under the assumption that the gradient of the potential (with respect to the weight vector) would be updated along the negative direction of the loss function to train the model. The update rule, in such cases, may assume that updating the gradient of the potential is based, not only on the loss function and learning rate, but on the auxiliary variables. This may be done as follows:

$$∇ ψ ( w ( t + 1 ) ) = ∇ ψ ( w ( t ) ) - η ( t ) ∇ {( {z}_{i ( t )} - \sqrt{ℓ ( f ( {x}_{i ( t )} , w ( t ) ) , {y}_{i ( t )} )} )}^{2} , \qquad ( 12 )$$

$$w ( 0 ) = {w}_{0} , z ( 0 ) = 0$$

In accordance with some embodiments, the gradient update term(s)

$$( e . g . , η ( t ) ∇ {( {z}_{i ( t )} - \sqrt{ℓ ( f ( {x}_{i ( t )} , w ( t ) ) , {y}_{i ( t )} )} )}^{2} , \frac{λ}{n} η ( t ) ( {z}_{i} ( t ) - \sqrt{ℓ ( f ( {x}_{i ( t )} , w ( t ) ) , {y}_{i ( t )} )} ) )$$

may be replaced by variations, including but not limited to (ones based on) Adam, AdamW, AdaGrad, RMSProp, Momentum, WeightDecay, etc. As can readily be appreciated, the specific manner in which the gradient update terms are calculated is largely dependent upon the requirements of specific applications.

Among all solutions that interpolate the training data, RMD may similarly be used to converge on one or more solutions that minimize the potential ψ(·). When RMD is initialized with w(0)=w₀, the minimizer of ψ(·), and z(0)=0, the weight vector may converge to the solution of:

$${min}_{w} [ {\sum }_{i = 1}^{n} ℓ ( f ( {x}_{i} , w ) , {y}_{i} ) + λ ψ ( w ) ] \qquad ( 13 )$$

where λ>0 is the regularization parameter mentioned earlier in the RMD recursions (explicit regularization). In doing so, λ determines the trade-off between how much we want to reduce the loss

$${\sum }_{i = 1}^{n} ℓ ( f ( {x}_{i} , w ) , {y}_{i} )$$

versus how much we want to reduce the regularizer ψ(w).

As mentioned above, an inversion (depending on an inverse mapping of the gradient of the potential ∇⁻¹ψ(·)) may be calculated for the actual process of updating the weight vector w(t) itself (in addition to the vector(s) of auxiliary variables). Furthermore, as above, these updates may be implemented in at least two variations: a one-step process and a two-step process. The one-step process may follow the equation:

$$w ( t + 1 ) = ∇ {ψ}^{- 1} [ ∇ ψ ( w ( t ) ) - η ( t ) ∇ {( {z}_{i ( t )} - \sqrt{ℓ ( f ( {x}_{i ( t )} , w ( t ) ) , {y}_{i ( t )} )} )}^{2} ] , \qquad ( 14 )$$

$$w ( 0 ) = {w}_{0} , z ( 0 ) = 0$$

Meanwhile, as above, the two-step method may alleviate the aforementioned numerical instability by computing the gradient of the potential at the point of initialization (∇ψ(w(0))) and continuously deriving and storing estimates for the gradient of the potential (at later time iterations) based on that initial estimate (in addition or alternative to variables including but not limited to the loss function and/or learning rate). The two-step process may thereby follow the equation:

$$\{ \begin{matrix}ξ ( t + 1 ) = ξ ( t ) - η ( t ) ∇ {( {z}_{i ( t )} - \sqrt{ℓ ( f ( {x}_{i ( t )} , w ( t ) ) , {y}_{i ( t )} )} )}^{2} , ξ ( 0 ) = ∇ ψ ( {w}_{0} ) , z ( 0 ) = 0 \\ w ( t + 1 ) = ∇ {ψ}^{- 1} ( ξ ( t + 1 ) ) .\end{matrix} \qquad ( 15 )$$

In accordance with multiple embodiments of the invention, RMD may be considered a broader instance of SMD. Specifically, as the regularization parameter of RMD, λ→0, the implicit regularization of SMD may be recovered. This can also be seen from the recursions for RMD (11-15) which reduce to their SMD counterparts by setting λ=0. When applied to network compression, the advantage of RMD over SMD is that systems implemented in accordance with certain embodiments of the invention may perform more aggressive simplifications by further reducing the value of the potential function ψ(·). In some instances, this may significantly improve accuracy. That said, this improvement may come at the price of slightly sacrificing on the training loss.

c. Special Cases for Different Potential Functions

In accordance with various embodiments of the invention, potential functions may vary in implementation. Specifically, distinct potential functions may be applied in order to optimize specific outcomes. Several variants on potential functions implemented in accordance with some embodiments of the invention are disclosed below.

i. q-Norm Potential

An important special case, for applications of mirror descent algorithms utilized in accordance with some embodiments of the invention, is when the potential function ψ(·) is chosen to be the [symbol] _{q} norm, frequently chosen as the potential function in order to optimize regularization. In doing so, the [symbol] _{q} norm may take the form:

$$ψ ( w ) = \frac{1}{q} {‖ w ‖}_{q}^{q} = \frac{1}{q} {\sum }_{k = 1}^{p} {\vert w ( k ) \vert}^{q} ,$$

for any positive integer q. Note that this choice of potential function is “separable,” in the sense that the update for the k-th element of the weight vector requires only the k-th element of the weight and gradient vectors. For example, let the current gradient be denoted by g:=∇Lᵢ(wₜ₋₁). In this case, the update rule can be written as:

$${{w}_{t} ( k ) = ‖ {w}_{t - 1} ( k ) \vert}^{q - 1} sign ( {w}_{t - 1} ( k ) ) + \frac{{ηℓ}^{′} ( {z}_{t - 1} ( i ) - \sqrt{2 {L}_{i} ( {w}_{t - 1} )} )}{\sqrt{2 {L}_{i} ( {w}_{t - 1} )}} g ( k ) {\vert}^{\frac{1}{q - 1}} \times sign ( {\vert {w}_{t - 1} ( k ) \vert}^{q - 1} sign ( {w}_{t - 1} ( k ) ) + \frac{{ηℓ}^{′} ( {z}_{t - 1} ( i ) - \sqrt{2 {L}_{i} ( {w}_{t - 1} )} )}{\sqrt{2 {L}_{i} ( {w}_{t - 1} )}} g ( k ) ) , ∀ k \qquad ( 16 )$$

$${z}_{t} ( i ) = {z}_{t - 1} ( i ) - \frac{η}{λ} {ℓ}^{′} ( {z}_{t - 1} ( i ) - \sqrt{2 {L}_{i} ( {w}_{t - 1} )} ) , {z}_{t} ( j ) = {z}_{t - 1} ( j ) , ∀ j \neq i ,$$

where wₜ(k) denotes the k-th element of wₜ (the weight vector at time t), and g(k) is the k-th element of the current gradient g. This allows for efficient (parallel) implementation of the algorithm. In certain embodiments,

$$ℓ ( \cdot ) = \frac{{( \cdot )}^{2}}{2} ,$$

which implies [symbol] ′(·)=(·) and simplifies the updates:

$${w}_{t} ( k ) = {\vert {\vert {w}_{t - 1} ( k ) \vert}^{q - 1} sign ( {w}_{t - 1} ( k ) ) + \frac{η ( {z}_{t - 1} ( i ) - \sqrt{2 {L}_{i} ( {w}_{t - 1} )} )}{\sqrt{2 {L}_{i} ( {w}_{t - 1} )}} g ( k ) \vert}^{\frac{1}{q - 1}} \times sign ( {\vert {w}_{t - 1} ( k ) \vert}^{q - 1} sign ( {w}_{t - 1} ( k ) ) + \frac{η ( {z}_{t - 1} ( i ) - \sqrt{2 {L}_{i} ( {w}_{t - 1} )} )}{\sqrt{2 {L}_{i} ( {w}_{t - 1} )}} g ( k ) ) , ∀ k \qquad ( 17 )$$

$${z}_{t} ( i ) = {z}_{t - 1} ( i ) - \frac{η}{λ} ( {z}_{t - 1} ( i ) - \sqrt{2 {L}_{i} ( {w}_{t - 1} )} ) , {z}_{t} ( j ) = {z}_{t - 1} ( j ) , ∀ j \neq i ,$$

Implementing compression-directed functionalities can modify how network models in accordance with various embodiments of the invention are primed. Moreover, in a number of embodiments, processes can use different q for different effects as q-norm regularization can have a different effect on the weights of the corresponding q. This can be especially impactful when performing compression processes implemented in accordance with some embodiments of the invention.

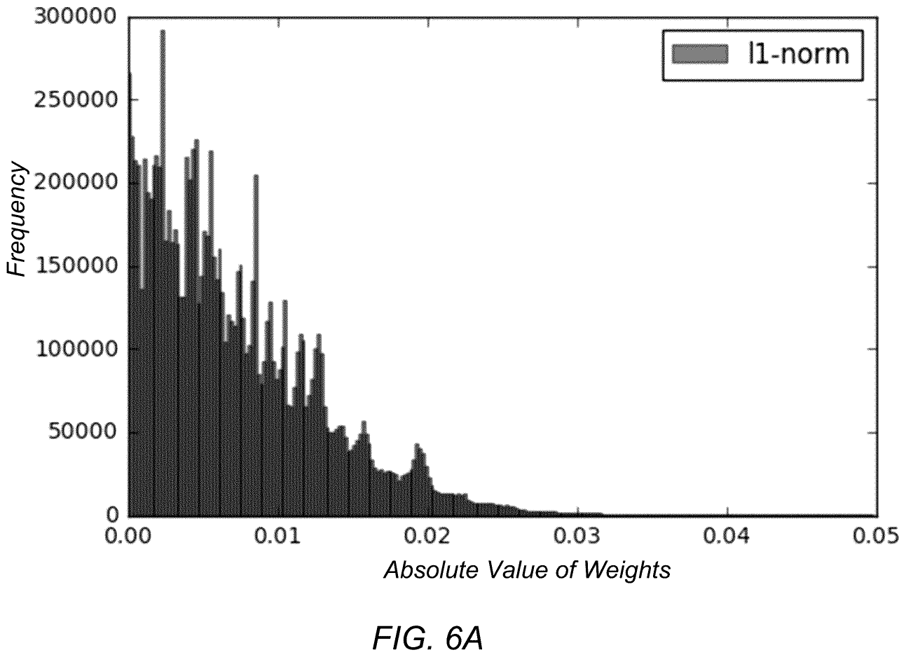

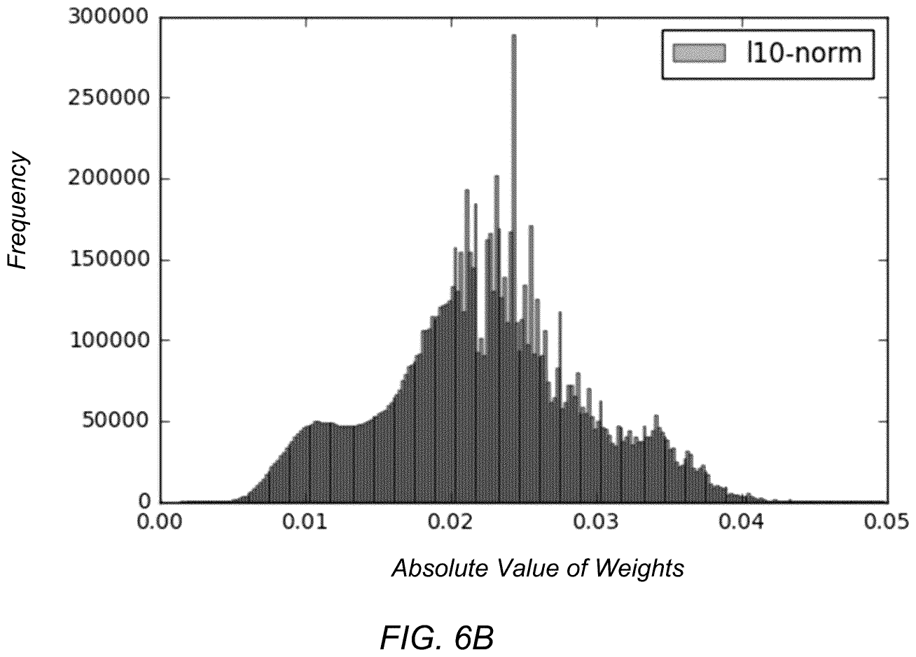

Histograms of the absolute value of the final weights in the network for different potentials are illustrated in FIGS. 6A and 6B. In this example, the solutions obtained by different SMD algorithms are vastly different from one another, even though they all fit the same training data and even though they were initialized with the same set of weight vectors, which highlights the role of the proposed algorithm for training. Each of the histograms corresponds to an 11×10⁶-dimensional weight vector that perfectly interpolates the data.

1. Quantization-Directed q-Norm Applications ( [symbol] _{∞})

In applying q-norm potentials to quantization, (strictly) convex potentials such as:

$$ψ ( w ) = {‖ w ‖}_{q}^{q} = {\sum }_{i = 1}^{p} {\vert {w}_{i} \vert}^{q} \qquad ( 18 )$$

for q»1, encourage the weights to concentrate around two bipolar values. Thus, running SMD (and RMD) for

$$ψ ( w ) = {‖ w ‖}_{q}^{q} ,$$

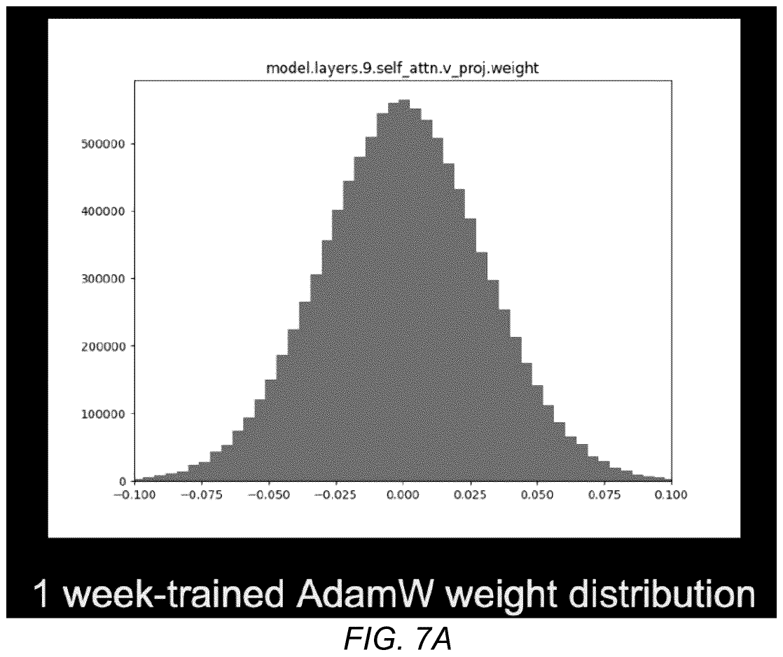

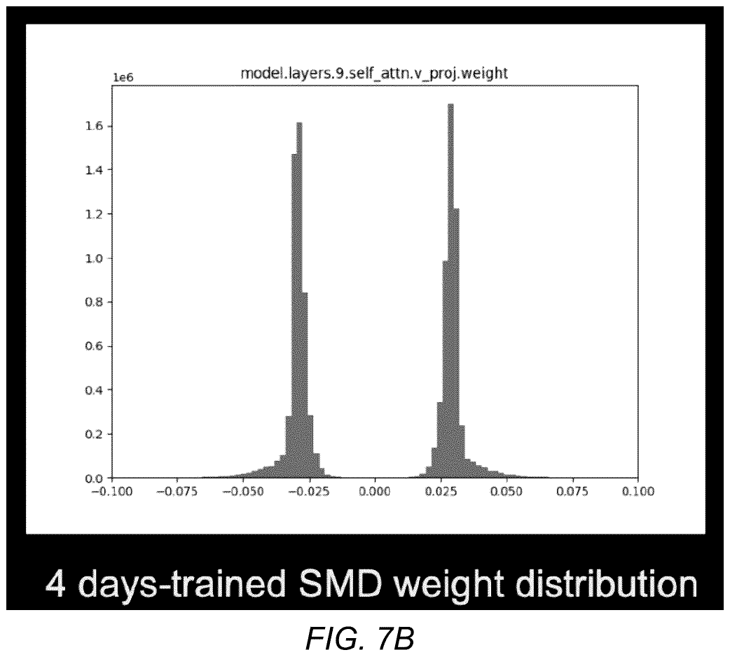

for q»1, when initialized by w₀=0 (or some weight vector close to zero), typically results in a final weight vector that is very close to bimodal. FIGS. 7A and 7B illustrate the effect that these training processes can have on network models implemented in accordance with numerous embodiments of the invention. Specifically, FIG. 7A effectively illustrates a weight distribution, corresponding to (one layer) of an LLM trained using standard processes. This distribution is distinctly unimodal and is shown to have a mode centered at (or near) zero. In contrast, FIG. 7B illustrates a layer of an LLM trained based on methods in accordance with multiple embodiments of the invention. The bimodal distribution, with modes centered roughly at weight values of roughly ±0.3, is far more easily quantized to a single bit (for example, one where the weights centered near −0.3 are quantized to “0” and those centered near 0.3 are quantized to “1”).

This configuration is especially effective when systems are priming networks for quantization. Specifically, [symbol] _{∞} norm regularization promotes bounded and small ranges of weights. With this choice of potential, the weights tend to concentrate around small intervals. This is often desirable in many implementations of neural networks since it can provide a small dynamic range for quantization of weights, which can reduce the production cost and computational complexity. However, since [symbol] _{∞} is not differentiable, processes in accordance with some embodiments of the invention can use a large value for q, e.g., q=10 and implement

$$ψ ( w ) = \frac{1}{10} {‖ w ‖}_{10}^{10}$$

to achieve the desirable regularization effect of [symbol] _{∞}. The histogram of the [symbol] ₁₀ SMD in FIG. 6A illustrates this regularization effect in practice. Specifically, after extended training, the distribution on the corresponding figure has completely moved away from zero, i.e., all the weights in the [symbol] ₁₀ solution are non-zero. This emphasizes how the quantization-optimizing approach corresponding to [symbol] ₁₀, which uses the entire overparameterization available in the network, generalizes especially effectively.

In several embodiments, when the potential is

$$ψ ( w ) = {‖ w ‖}_{q}^{q} ,$$

systems configured in accordance with multiple embodiments of the invention may determine:

$${[ ∇ ψ ( w ) ]}_{i} = {qw}_{i} {\vert {w}_{i} \vert}^{q - 2} = q {\vert {w}_{i} \vert}^{q - 1} sign ( {w}_{i} ) \qquad ( 19 )$$

where [∇ψ(w)]ᵢ and wᵢ are the ith components of the vectors ∇ψ(w) and w, respectively. In such cases, the inverse of the gradient of the potential may be given by:

$${[ {∇}^{- 1} ψ ( w ) ]}_{i} = \frac{{\vert {x}_{i} \vert}^{\frac{2 - q}{q - 1}}}{{q}^{\frac{1}{q - 1}}} \cdot {x}_{i} = {( \frac{\vert {x}_{i} \vert}{q} )}^{\frac{1}{q - 1}} \cdot sign ( {x}_{1} ) . \qquad ( 20 )$$

By using the above ( [symbol] _{q} norm-directed) equations (19) and (20) with the inverse mapping (of the gradient of the potential) required for the weight update processes of equation (9) for SMD (or equation (14) for RMD), systems in accordance with some embodiments may implement the one-step process for SMD with a [symbol] _{q} norm. By doing the same with equation (10) for SMD (or equation (15) for RMD), systems may implement the two-step process. Nevertheless, in the latter case, as expressed above, the need for equation (19) (i. e., [∇ψ(w)]ᵢ) may be limited only to the time iteration of initialization (e.g., while equation (20) is used at every iteration).
2. Pruning-Directed q-Norm Applications ( [symbol] ₁)

In contrast, where q=1+ϵ, 1>>ϵ>0 (i.e., 2>>q>1), SMD (and/or RMD) is running for

$$ψ ( w ) = {‖ w ‖}_{1 + ϵ}^{1 + ϵ} ,$$

and the corresponding model initialized by w₀=0 (or some weight vector close to zero), systems implementing processes in accordance with a number of embodiments may result in a final weight vector that is sparse. Specifically, [symbol] ₁ norm regularization promotes sparsity in the weights, which is often desirable for reducing the storage and computational load, since deep neural networks often have millions or billions of weights. However, since the [symbol] ₁ norm is not differentiable or strictly convex, processes in accordance with many embodiments of the invention can use

$$ψ ( w ) = \frac{1}{1 + ϵ} {‖ w ‖}_{1 + ϵ}^{1 + ϵ}$$

for some small ϵ>0. The histogram of the [symbol] ₁ SMD in FIG. 6B illustrates the effect of this form of training on the sparsity of the weight distribution. Specifically, the histogram of the [symbol] ₁-SMD in FIG. 6B has more weights at and around zero, i.e., it is very sparse.

Moreover, when the potential is

$$ψ ( w ) = {‖ w ‖}_{1 + ϵ}^{1 + ϵ} ,$$

systems configured in accordance with some embodiments may determine:

$${[ ∇ ψ ( w ) ]}_{i} = ( 1 + ϵ ) \frac{{w}_{i}}{{\vert {w}_{i} \vert}^{1 - ϵ}} = ( 1 + ϵ ) {\vert {w}_{i} \vert}^{ϵ} sign ( {w}_{i} ) , \qquad ( 21 )$$

where [∇ψ(w)]ᵢ and wᵢ are the ith components of the vectors ∇ψ(w) and w, respectively. In such cases, the inverse of the gradient of the potential may be given by:

$${[ {∇}^{- 1} ψ ( w ) ]}_{i} = \frac{{\vert {x}_{i} \vert}^{\frac{1 - ϵ}{ϵ}}}{{( 1 + ϵ )}^{1 / ϵ}} {x}_{i} = {( \frac{\vert {x}_{i} \vert}{1 + ϵ} )}^{1 / ϵ} sign ( {x}_{i} ) . \qquad ( 22 )$$

By using the above ( [symbol] _{q} norm-directed) equations (21) and (22) with the inverse mapping (of the gradient of the potential) required for the weight update processes of equation (9) for SMD (or equation (14) for RMD), systems in accordance with various embodiments may implement the one-step process for SMD with a [symbol] _{q} norm. By doing the same with equation (10) for SMD (or equation (15) for RMD), systems may implement the two-step process. Nevertheless, in the latter case, as expressed above, the need for equation (21) (i. e., [∇ψ(w)]ᵢ) may be limited only to the time iteration of initialization (e.g., while equation (22) is used at every iteration).

### 3. Joint Compression

Systems and methods in accordance with various embodiments of the invention may use multiple compression processes in tandem. For example, systems may be configured to jointly prune and quantize the parameters in a neural network. As suggested above, taking the potential as the [symbol] _{1+ϵ} norm, with a small ϵ>0, encourages the parameters to be sparse, and hence prunable. Therefore one possible framework (to allow SMD and/or RMD) to jointly prune and quantize is to take:

$$ψ ( w ) = {{\sum }_{i = 1}}^{p} max ( {\vert {w}_{i} \vert}^{1 + ϵ} , β {\vert {w}_{i} \vert}^{q} ) \qquad ( 23 )$$

where 1»ϵ>0, q»1, and β>0 is a constant that weighs the relative norm potentials.

When the potential follows the above configuration, systems configured in accordance with many embodiments may determine:

$${[ ∇ ψ ( w ) ]}_{i} = \{ \begin{matrix}( 1 + ϵ ) {\vert {w}_{i} \vert}^{ϵ} \cdot sign ( {w}_{i} ) & if \vert {w}_{i} \vert < {( \frac{1}{β} )}^{\frac{1}{q - 1 - ϵ}} \\ [ ( 1 + ϵ ) {\vert {w}_{i} \vert}^{ϵ} , β q {\vert {w}_{i} \vert}^{q - 1} ] sign ( {w}_{i} ) & if \vert {w}_{i} \vert = {( \frac{1}{β} )}^{\frac{1}{q - 1 - ϵ}} \\ β q {\vert {w}_{i} \vert}^{q - 1} \cdot sign ( {w}_{i} ) & if \vert {w}_{i} \vert > {( \frac{1}{β} )}^{\frac{1}{q - 1 - ϵ}}\end{matrix} \qquad ( 24 )$$

As above, [∇ψ(w)]ᵢ and wᵢ are the ith components of the vectors ∇ψ(w) and w, respectively. Note that the above gradient is one-to-many since any weights with absolute value

$${( \frac{1}{β} )}^{\frac{1}{q - 1 - ϵ}}$$

can get mapped to an entire interval. In these cases, the inverse of the gradient of the potential may be given by:

$${[ {∇}^{- 1} ψ ( w ) ]}_{i} = \{ \begin{matrix}{( \frac{\vert {x}_{i} \vert}{1 + ϵ} )}^{\frac{1}{ϵ}} \cdot sign ( {x}_{i} ) & if \vert {x}_{i} \vert < ( 1 + ϵ ) {( \frac{1}{β} )}^{\frac{ϵ}{q - 1 - ϵ}} \\ {( \frac{\vert {x}_{i} \vert}{β q} )}^{\frac{1}{q - 1}} \cdot sign ( {x}_{i} ) & if \vert {x}_{i} \vert > q {( \frac{1}{β} )}^{\frac{ϵ}{q - 1 - ϵ}} \\ {( \frac{1}{β} )}^{\frac{1}{q - 1 - ϵ}} \cdot sign ( {x}_{i} ) & otherwise\end{matrix} \qquad ( 25 )$$

Note that the above inverse gradient is many-to-one if the absolute value of any component of x is in the interval

$$[ ( 1 + ε ) {( \frac{1}{β} )}^{\frac{ϵ}{q - 1 - ϵ}} , q {( \frac{1}{β} )}^{\frac{ϵ}{q - 1 - ϵ}} ] ,$$

it gets mapped to the single point with absolute value

$${( \frac{1}{β} )}^{\frac{1}{q - 1 - ϵ}} .$$

By using the above ( [symbol] _{q} norm-directed) equations (24) and (25) with the inverse mapping (of the gradient of the potential) required for the weight update processes of equation (9) for SMD (or equation (14) for RMD), systems in accordance with several embodiments may implement the one-step process for SMD with a [symbol] _{q} norm. By doing the same with equation (10) for SMD (or equation (15) for RMD), systems may implement the two-step process. Nevertheless, in the latter case, as expressed above, the need for equation (24) (i. e., [∇ψ(w)]ᵢ) may be limited only to the time iteration of initialization (e.g., while equation (25) is used at every iteration).

ii. Additional Quantization Variations

Systems and methods in accordance with various embodiments of the invention may utilize variations on and/or alternatives to the above potential and loss function configurations with respect to quantization. A number of alternative potential and loss functions that can be utilized in various embodiments of the invention are discussed further below.

### 1. Rigid Cage Quantization

In several embodiments of the invention, an alternative convex potential function (the “rigid cage” potential function) may be implemented to obtain bimodal weight convergence. When applied to SMD, this function may follow the formula:

$$ψ ( w ) = {‖ w ‖}_{∞} + \frac{ϵ}{2} {‖ w ‖}^{2} = {max}_{i = 1 , … , p} {\vert w \vert}_{i} + \frac{ϵ}{2} {\sum }_{i = 1}^{p} {w}_{i}^{2} \qquad ( 26 )$$

for small ϵ>0 where ∥w∥_{∞}=maxᵢ|wᵢ| represents the largest element of w in absolute value. In numerous embodiments, running SMD for

$$ψ ( w ) = {‖ w ‖}_{∞} + \frac{ϵ}{2} {‖ w ‖}^{2} ,$$

when initialized by w₀=0 (and/or where the entries of the weight vector are mostly zero), can result in a final weight vector that is close to bimodal. The rigid cage potential function for RMD similarly may follow the same formula:

$$ψ ( w ) = {‖ w ‖}_{∞} + \frac{ϵ}{2} {‖ w ‖}^{2} \\ for q ≫ 1.$$

When the potential function follows the above configuration,

$$ψ ( w ) = {‖ w ‖}_{∞} + \frac{ϵ}{2} {‖ w ‖}^{2} ,$$

the gradient of the potential may be set to:

$$∇ ψ = s + ϵ w , where {‖ s ‖}_{1} = 1 and {s}_{i} = 0 , if \vert {w}_{i} \vert < {‖ w ‖}_{∞} . \qquad ( 27 )$$

where the gradient is a one-to-many mapping. When the absolute value of multiple components of w match ∥w∥_{∞}, i.e., when multiple components attain the maximum, then s can be any vector of unit [symbol] ₁ norm on the support of components that achieve this maximum.

In cases where, during initialization of the weights w(0)=w₀, there are multiple entries of w₀ that achieve ∥w₀∥_{∞}, then the gradient ∇ψ(w₀) may be considered non-unique. Any vector s, with the appropriate signs and unit [symbol] ₁ norm on the support of the maximum-achieving entries, gives a valid gradient. In various embodiments of the invention s may be chosen uniformly at random, subject to these constraints.

In some embodiments of the invention, gradient and inverse gradient computations may or may not be done component-wise (e.g., [∇ψ(w)]ᵢ depending only on wᵢ and [∇ψ(x)]ᵢ depending only on xᵢ). In the rigid cage implementation especially, neither mapping may need to be done component-wise. Specifically, the s vector in the gradient may depend on all the entries w attaining ∥w∥_{∞}. The required sorting may add to the computational complexity of each update step. In such cases, sorting p numbers involves a complexity of (p log p), whereas each gradient update is O(p). This can potentially lead to a slow down of O(log p) in training the model. Fortunately, at time t, the gradient vector ∇ψ(w(t))=x(t) has already been sorted. Therefore, since the gradient update x(t+1)=∇ψ(w(t+1))=∇ψ(w(t))−η∇ [symbol] (t,w(t))=x(t)−η∇ [symbol] (t,w(t)) only slightly perturbs x(t), it can be expected that the ordering of the components of x(t+1) may not be significantly different from the ordering of the components of x(t). This can be used to speed up the sorting of x(t+1) from O(p log p), since x(t) is already sorted. There are many fast algorithms to sort “mostly sorted arrays” that can be applied in a similar fashion in accordance with various embodiments of the invention.

In various embodiments of the invention, the inverse of the gradient mapping ∇⁻¹ψ(x), for any vector x, can be found in the following fashion:
(1) Sort the magnitude of the entries of x in descending order, i.e|xᵢ_{₁}|≥|xᵢ_{₂}|≥ . . . , |xᵢ_{ₚ}|.
(2) Find the largest value of k such that

$${\sum }_{j = 1}^{k} \vert {x}_{{i}_{j}} \vert > k \vert {x}_{{i}_{k + 1}} \vert + 1$$

(3) Set

$$α = \frac{{\sum }_{j = 1}^{k} \vert {x}_{{i}_{j}} \vert - 1}{k} ;$$

on doing so, the inverse gradient may follow the form:

$${[ {∇}^{- 1} ψ ( x ) ]}_{{i}_{j}} = \{ \begin{matrix}\frac{α}{ϵ} \cdot sign ( {x}_{{i}_{j}} ) & j = 1 , … , k \\ {x}_{{i}_{j}} & j = k + 1 , … , p\end{matrix} \qquad ( 28 )$$

In accordance with miscellaneous embodiments of the invention, the inverse of the gradient may follow a many-to-one mapping. In particular, this is because any vector x which satisfies step 2 has its k largest components mapped to

$$\frac{α}{ϵ}$$

(in absolute value). Moreover, as mentioned above, the inverse mapping may not be done component-wise. Specifically, this mapping involves sorting the components of x by absolute value and computing the values of α and k from (potentially) all the entries, adding to the computational complexity of each update step.

For this reason, the rigid cage SMD (and/or RMD) may be used to quantize weights to one-bit because the inverse gradient mapping in the SMD updates may force the weights to all have the same absolute value. By using the above (rigid cage-directed) equations (27) and (28) with the inverse mapping (of the gradient of the potential) required for the weight update processes of equation (10) for SMD (or equation (15) for RMD), systems in accordance with multiple embodiments may implement the two-step process for updating weights (using mirror descent algorithms with a rigid cage configuration). Systems in accordance with various embodiments of the invention may elect to avoid a one-step version of rigid cage-based mirror descent algorithms. This may be done on the basis that only storing the weights w(t) may, at each time t, cause ambiguity with regards to computing ∇ψ(w(t)) for those components of w(t) that achieve ∥w(t)∥_{∞}. The two-step procedure avoids this because it stores and propagates ξ(t)=∇ψ(w(t)) at each iteration and never needs to compute it from the weights. In the two-step case, as expressed above, the need for equation (27) (i.e., [∇⁻¹ψ(x)]ᵢ_{ⱼ}) may be limited only to the time iteration of initialization (e.g., while equation (28) is used at every iteration). In particular, as referenced above, the fact that equation (28) is many-to-one and maps the top k (in magnitude) components of the gradient to the same value may allow systems in accordance with some embodiments to quantize to a single bit.

### 2. Kurtosis Quantization

Systems and methods in accordance with numerous embodiments of the invention may, additionally or alternatively, improve the impact of mirror descent on quantization by modifying the loss functions [symbol] ( [symbol] ). In various embodiments, SMD and/or RMD may be bolstered (e.g., with respect to quantization) by adding Kurtosis terms to the loss functions. For example, for a given network with k layers, where the weights in the ith layer of the network are denoted by the vector w (i), the Kurtosis loss term may take the form:

$${ℓ}_{k u r} ( w ) = {\sum }_{i = 1}^{k} {\sum }_{j = 1}^{{p}_{i}} {( {\vert {w}_{j}^{( i )} \vert}^{4} - {( \frac{1}{{p}_{i}} {\sum }_{j = 1}^{{p}_{i}} \vert {w}_{j}^{( i )} \vert )}^{4} )}^{2} \qquad ( 29 )$$

where pᵢ is the number of weights in the ith layer and

$${\sum }_{i = 1}^{k} {p}_{i} = p .$$

When using Kurtosis loss terms, optimization of the loss may then take the form:

$$ℓ ( f ( x , w , ) , y ) + {δℓ}_{k u r} ( w ) \qquad ( 30 )$$

where δ>0 is a small constant.

In some embodiments of the invention, Kurtosis loss may be considered alongside various potential functions including but not limited to the [symbol] _{q} potential and the rigid cage potential. Systems in accordance with some embodiments may implement the process for SMD (and/or RMD) with various potential functions including but not limited to a [symbol] _{q} norm potential and/or a rigid cage potential. In these cases, the gradient of the loss (for the Kurtosis term) may take the form:

$${[ ∇ {ℓ}_{k u r} ( w ) ]}_{j}^{( i )} = 8 ( {\vert {w}_{j}^{( i )} \vert}^{4} - {( \frac{1}{{p}_{i}} {‖ {w}_{j}^{( i )} ‖}_{1} )}^{4} ) \cdot ( {\vert {w}_{j}^{( i )} \vert}^{3} - \frac{1}{{p}_{i}^{4}} \cdot {‖ {w}_{j}^{( i )} ‖}_{1}^{3} \cdot \vert {w}_{j}^{( i )} \vert ) sign ( {w}_{j}^{( i )} ) \qquad ( 31 )$$

In such cases, the above gradient (with the weighting β>0) may be added to the (gradient of the) standard loss to update the gradient of the loss (e.g., that is used to update weight estimates as in equations (9), (10), (14), and/or (15)). As referenced above, this may be done in a one-step and/or two-step process as in the above scenarios.
iii. Additional Pruning Variations

Systems and methods in accordance with some embodiments of the invention may, additionally or alternatively, utilize variations on and/or alternatives to the above potential and loss function configurations with respect to pruning.

### 1. Elastic Net Pruning

In several embodiments of the invention, an alternative convex potential function (the “elastic net” potential function) may be implemented to encourage derivation of sparse (final) weight vectors. When applied to SMD, this function may follow the formula:

$$ψ ( w ) = {‖ w ‖}_{1} + \frac{ϵ}{2} {‖ w ‖}^{2} = {\sum }_{i = 1}^{p} ( \vert {w}_{i} \vert + \frac{ϵ}{2} {w}_{i}^{2} ) , \qquad ( 32 )$$

for small ϵ>0. In some embodiments, running SMD for

$$ψ ( w ) = {‖ w ‖}_{1} + \frac{ϵ}{2} {‖ w ‖}^{2} ,$$

when initialized by w₀=0 (and/or where the entries of the weight vector are mostly zero), will result in a final weight vector that is sparse. The elastic net potential for RMD may follow the same formula:

$$ψ ( w ) = {‖ w ‖}_{1} + \frac{ϵ}{2} {‖ w ‖}^{2} = {\sum }_{i = 1}^{p} ( \vert {w}_{i} \vert + \frac{ϵ}{2} {w}_{i}^{2} ) ,$$

for small ϵ>0.

When the potential is

$$ψ ( w ) = {‖ w ‖}_{1} + \frac{ϵ}{2} {‖ w ‖}^{2} ,$$

the gradient of the potential may be set to:

$${[ ∇ ψ ( w ) ]}_{i} = \{ \begin{matrix}( \frac{1}{\vert {w}_{i} \vert} + ϵ ) {w}_{i} = sign ( {w}_{i} ) + {ϵw}_{i} & if {w}_{i} \neq 0 \\ v , \vert v \vert \leq 1 & if {w}_{i} = 0\end{matrix} . \qquad ( 33 )$$

where the gradient is a one-to-many mapping (since, when a component of w is zero, the corresponding component of the gradient can be any magnitude no greater than one).

Additionally or alternatively, the inverse of the gradient may follow the form:

$${[ {∇}^{- 1} ψ ( x ) ]}_{i} = \{ \begin{matrix}( \vert {x}_{i} \vert - 1 ) \frac{sign ( {x}_{i} )}{ϵ} & if \vert {x}_{i} \vert \geq 1 \\ 0 & if \vert {x}_{i} \vert < 1\end{matrix} . \qquad ( 34 )$$

where the inverse of the gradient is a many-to-one mapping (since, when a component of x has magnitude less than one the corresponding component of the inverse gradient is zero). The above configuration may enable SMD (and/or RMD) implemented using the elastic net to prune weights because the inverse gradient mappings (e.g., equations (9), (10), (14), and (15)) may force some of the weights to be zero.

By using the above (elastic net-directed) equations (33) and (34) with the inverse mapping (of the gradient of the potential) required for the weight update processes of equation (10) for SMD (or equation (15) for RMD), systems in accordance with certain embodiments may implement the two-step process for updating weights (via mirror descent algorithms with elastic net configurations). Systems in accordance with various embodiments of the invention may elect to avoid a one-step version of elastic net-based mirror descent algorithms. This may be done on the basis that only storing the weights w(t) may, at each time t, cause ambiguity with regards to computing ∇ψ(w(t)) for those components of w(t) that are zero. In the two-step procedure storing and propagating ξ(t)=∇ψ(w(t)) at each iteration avoids the need to compute it from the weights.

In accordance with many embodiments of the invention, in implementing the elastic net mirror descent algorithm, when at least one component of the initial weight vector w(0)=w₀ is set to a non-zero value, then after convergence it may remain zero and preserve the sign of what it was initialized to. Therefore, to maximize the amount of pruning in elastic net mirror descent algorithms, systems in accordance with various embodiments may initialize with all zero weight vector(s). In some cases, as initializing the weights in all zeros may result in zero gradients (meaning that training will not happen) for some neural networks, systems may be configured to initialize with weight vectors with (very few) nonzero elements that are sufficient to result in nonzero gradients and to jumpstart the training process. In doing this, for weights that are initially set to zero, the corresponding components of the gradient can be set to any value in the interval [−1,1]. For example, systems may optimize the process by choosing components of the gradient uniformly.

### 2. Group Pruning

Systems in accordance with various embodiments of the invention may facilitate simultaneous pruning of entire groups of weights. For example, in a neural network, systems may be configured to remove an entire neuron (and all the weights that are connected to it). In such cases, for a scenario where weights are partitioned into k groups:

$$w = [ \begin{matrix}{w}^{( 1 )} \\ {w}^{( 2 )} \\ ⋮ \\ {w}^{( k )}\end{matrix} ]$$

two potentials that may be used, by mirror descent algorithms performed in accordance with multiple embodiments of the invention, to encourage group sparsity may include (but are not limited to):

$$ψ ( w ) = {\sum }_{i = 1}^{k} {‖ {w}^{( i )} ‖}^{1 + ϵ} ; and \qquad ( 35 A )$$

$$ψ ( w ) = {\sum }_{i = 1}^{k} ( ‖ {w}^{( i )} ‖ + \frac{ϵ}{2} {‖ {w}^{( i )} ‖}^{2} ) , \qquad ( 35 B )$$

for small ϵ>0. In accordance with some embodiments of the invention, systems may be configured to update weights using the above potential functions.

When the weight vector is partitioned into k groups:

$$w = [ \begin{matrix}{w}^{( 1 )} \\ {w}^{( 2 )} \\ ⋮ \\ {w}^{( k )}\end{matrix} ] ,$$

and the potential

$$ψ ( w ) = {\sum }_{i = 1}^{k} {‖ {w}^{( i )} ‖}^{1 + ϵ} ,$$

systems configured in accordance with multiple embodiments of the invention may determine:

$${[ ∇ ψ ( w ) ]}^{( i )} = ( 1 + ϵ ) \frac{{w}^{( i )}}{{‖ {w}^{( i )} ‖}^{1 - ϵ}} , \qquad ( 36 )$$

where w⁽ⁱ⁾ is the weight vector of the i th group and [∇ψ(w)]⁽ⁱ⁾ is the corresponding weight vector of the gradient of the potential. Additionally or alternatively, the inverse of the gradient of the potential may be given by:

$${[ {∇}^{- 1} ψ ( x ) ]}^{( i )} = \frac{{‖ {x}^{( i )} ‖}^{\frac{1 - ϵ}{ϵ}}}{{( 1 + ϵ )}^{1 / ϵ}} {x}^{( i )} . \qquad ( 37 )$$

By using the above ( [symbol] _{q} norm-directed) equations (36) and (37) with the inverse mapping (of the gradient of the potential) required for the weight update processes of equation (9) for SMD (or equation (14) for RMD), systems in accordance with some embodiments may implement the one-step process for mirror descent with a [symbol] _{q} norm. By doing the same with equation (10) for SMD (or equation (15) for RMD), systems may implement the two-step process. Nevertheless, in the latter case, as expressed above, the need for equation (36) (i.e., [∇ψ(w)]ᵢ) may be limited to the time iteration of initialization (e.g., while equation (37) is used at every iteration).

When the weight vector is partitioned into k groups:

$$w = [ \begin{matrix}{w}^{( 1 )} \\ {w}^{( 2 )} \\ ⋮ \\ {w}^{( k )}\end{matrix} ] ,$$

and the potential

$$ψ ( w ) = {\sum }_{i = 1}^{k} ( ‖ {w}^{( i )} ‖ + \frac{ϵ}{2} {‖ {w}^{( i )} ‖}^{2} ) ,$$

systems configured in accordance with several embodiments of the invention may determine:

$${[ ∇ ψ ( w ) ]}^{( i )} = \{ \begin{matrix}( \frac{1}{‖ {w}^{( i )} ‖} + ϵ ) {w}^{( i )} & if {w}^{( i )} \neq 0 \\ v , ‖ v ‖ \leq 1 & if {w}^{( i )} = 0\end{matrix} . \qquad ( 38 )$$

where w⁽ⁱ⁾ is the weight vector of the i th group and [∇ψ(w)]⁽ⁱ⁾ is the corresponding weight vector of the gradient of the potential. In these cases, the gradient is a one-to-many mapping, since if a group component of w is the all zero vector then the corresponding group component of the gradient can be any vector of norm no greater than one.

Additionally or alternatively, the inverse of the gradient of the potential may be given by:

$${[ {∇}^{- 1} ψ ( x ) ]}^{( i )} = \{ \begin{matrix}\frac{‖ {x}^{( i )} ‖ - 1}{ϵ ‖ {x}^{( i )} ‖} {x}^{( i )} & if ‖ {x}^{( i )} ‖ \geq 1 \\ 0 & if ‖ {x}^{( i )} ‖ < 1\end{matrix} . \qquad ( 39 )$$

In these cases, the inverse of the gradient is a many-to-one mapping, since when a group component of x has a norm that is less than one, the corresponding group component of the inverse gradient may be an all zero vector. Using the above formulae, the elastic net SMD may simultaneously prune all the weights in a group through mirror descent algorithms on the basis that the inverse gradient mapping forces some of the group weights to be the all zero vector.

In accordance with several embodiments of the invention, elastic net potential functions may be used alongside attempts at group pruning (“group pruning elastic net” configurations). In such cases, by using the above (elastic net-directed) equations (38) and (39) with the inverse mapping (of the gradient of the potential) required for the weight update processes of equation (10) for SMD (or equation (15) for RMD), systems in accordance with various embodiments may implement the two-step process for updating weights (using mirror descent algorithms with group pruning elastic net configurations). Systems in accordance with many embodiments of the invention may elect to avoid a one-step version of group pruning elastic net-based mirror descent algorithms. This may be done on the basis that only storing the weights w(t) may, at each time t, cause ambiguity with regards to computing ∇ψ(w(t)) for those components of w(t) that are zero vectors. In the two-step procedure storing and propagating ξ(t)=∇ψ(w(t)) at each iteration avoids the need to compute it from the weights.

In accordance with many embodiments of the invention, in implementing the elastic net mirror descent algorithm, when at least one component of the initial weight vector w(0)=w₀ is set to a non-zero value, then after convergence it may remain zero and preserve the direction of what it was initialized to. Therefore, to maximize the amount of pruning in elastic net mirror descent algorithms, systems in accordance with miscellaneous embodiments may initialize every group with the all zero weight vector. As initializing the weights as all zeros may result in zero gradients (meaning that training will not happen) for some neural networks, systems may be configured to initialize with weight vectors with very few (groups of) nonzero elements that are sufficient to result in nonzero gradients and to jumpstart the training process. In doing this, for weights that are initially set to zero, the corresponding components of the gradient can be set to any value whose norm is ≤1. For example, systems may optimize the process by choosing components of the gradient uniformly from within a unit ball.

Systems and methods in accordance with various embodiments of the invention are not limited to the above compression objectives. Accordingly, it should be appreciated that the capabilities of SMD and/or RMD algorithms described above with respect to FIGS. 5-7 can also be implemented outside the context of quantization and/or pruning. As can readily be appreciated, the specific objectives pursued during training-concurrent compression processes implemented in accordance with various embodiments of the invention are largely dependent upon the requirements of specific applications.

### III. Model Training

### A. Training System

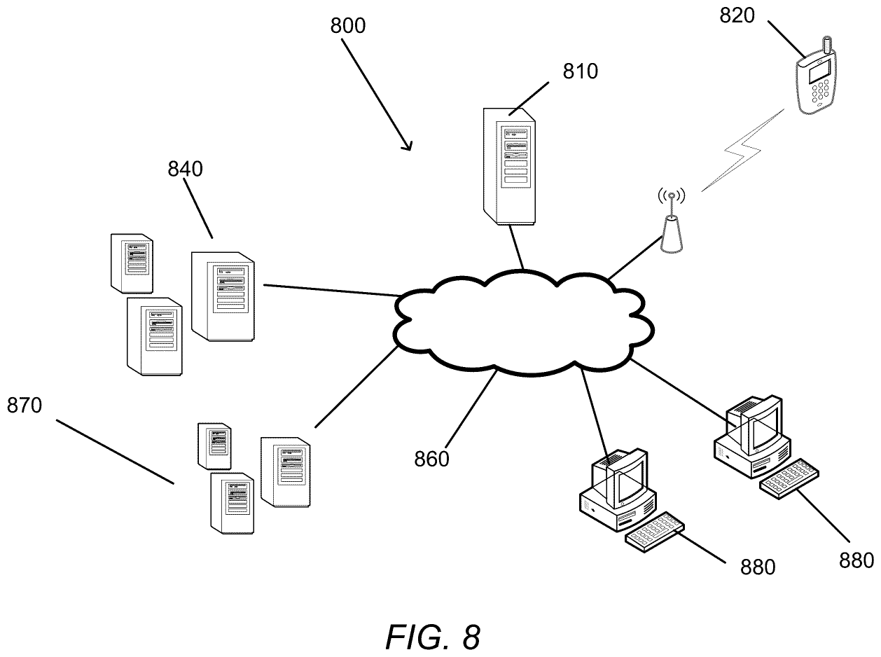

An example of a training system that trains models in accordance with miscellaneous embodiments of the invention is illustrated in FIG. 8. The training system 800 includes one or more server systems such as (but not limited to) point of presence (PoP) servers 810, inference servers 840, and/or data center servers 870 that are connected via a communications network 860. In many embodiments, one or more data center servers 870 gather data and train one or models using a training-concurrent compression process such as (but not limited to) any of the various training-concurrent compression processes described above. The trained models can then be deployed to one or more inference server clusters that can be distributed geographically to enable low-latency responses to requests from user devices. In a number of embodiments, point of presence servers 810 communicate with user devices and route requests to a proximate inference server capable of responding to a request using trained machine learning models. In many embodiments, multiple trained models are deployed within the network and the point of presence servers route requests to inference servers that have the capability to generate responses using a particular trained model relevant to the request. In a number of embodiments, the server systems utilized in one or more of the PoP servers 810, inference servers 840, and/or data center servers 870 can be implemented using the NVIDIA HGX AI platform manufactured by Nvidia Corp. of Sunnyvale, California.

The communications network 860 can be a network such as the Internet that allows devices connected to the network 860 to communicate with other connected devices. Server systems 810, 840, and 870 are connected to the network 860. Each of the server systems 810, 840, and 870 is a group of one or more servers communicatively connected to one another via internal networks that execute processes that provide cloud services to users over the network 860. One skilled in the art will recognize that a training system may exclude certain components and/or include other components that are omitted for brevity without departing from this invention. As can readily be appreciated, the specific architectures of given training systems largely depend upon the requirements of specific applications.

For purposes of this discussion, cloud services are one or more applications that are executed by one or more server systems to provide data and/or executable applications to devices over a network. The server systems 810, 840, and 870 are shown each having three servers in the internal network. However, the server systems 810, 840 and 870 may include any number of servers and any additional number of server systems may be connected to the network 860 to provide cloud services. In accordance with various embodiments of this invention, a training system that uses systems and methods that train and/or utilize models in accordance with an embodiment of the invention may be provided by a process being executed on a single server system and/or a group of server systems communicating over network 860.

Users may use personal devices 880 and 820 that connect to the network 860 to perform processes that train and/or utilize models in accordance with various embodiments of the invention. In the shown embodiment, the personal devices 880 are shown as desktop computers that are connected via a conventional “wired” connection to the network 860. However, the personal device 880 may be a desktop computer, a laptop computer, a smart television, an entertainment gaming console, or any other device that connects to the network 860 via a “wired” connection. The mobile device 820 connects to network 860 using a wireless connection. A wireless connection is a connection that uses Radio Frequency (RF) signals, Infrared signals, or any other form of wireless signaling to connect to the network 860. In the example of this figure, the mobile device 820 is a mobile telephone. However, mobile device 820 may be a mobile phone, Personal Digital Assistant (PDA), a tablet, a smartphone, or any other type of device that connects to network 860 via wireless connection without departing from this invention.

As can readily be appreciated the specific computing system used to train models is largely dependent upon the requirements of a given application and should not be considered as limited to any specific computing system(s) implementation.

### B. Training Element

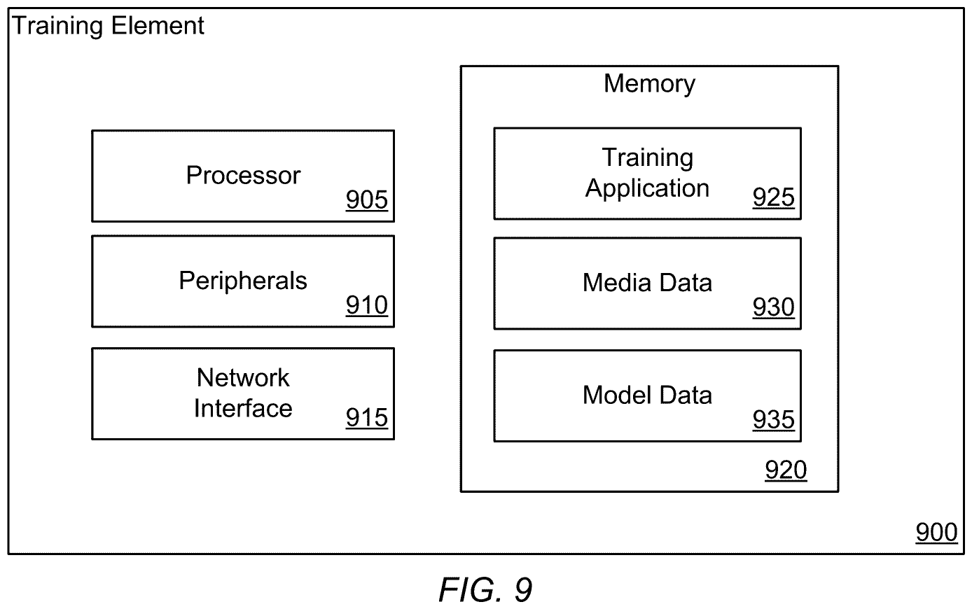

An example of a training element that executes instructions to perform processes that train and/or utilize models in accordance with various embodiments of the invention is illustrated in FIG. 9. Training elements in accordance with many embodiments of the invention can include (but are not limited to) one or more of mobile devices, cameras, and/or computers. Training element 900 includes processor 905, peripherals 910, network interface 915, and memory 920. One skilled in the art will recognize that a training element 900 may exclude certain components and/or include other components that are omitted for brevity without departing from this invention.

The processor 905 can include (but is not limited to) a processor, microprocessor, controller, or a combination of processors, microprocessor, and/or controllers that performs instructions stored in the memory 920 to manipulate data stored in the memory. Processor instructions can configure the processor 905 to perform processes in accordance with certain embodiments of the invention.

Peripherals 910 can include any of a variety of components for capturing data, such as (but not limited to) cameras, displays, and/or sensors. In a variety of embodiments, peripherals 910 can be used to gather inputs and/or provide outputs. Training elements 900 can utilize network interfaces 915 to transmit and receive data over a network based upon the instructions performed by processor 905. Peripherals 910 and/or network interfaces 915 in accordance with many embodiments of the invention can be used to gather inputs that can be used to train models operating in accordance with many embodiments of the invention.

Memory 920 includes a training application 925, training data 930, and model data 935. Training applications in accordance with several embodiments of the invention can be used to train models using potential functions, weight vectors, and/or auxiliary variables.

Training data 930 in accordance with many embodiments of the invention can include various types of training data 930 (or samples), such as (but not limited to) video, audio, text, images, etc. In various embodiments, training data 930 may include labels for the training data. Training data 930 in accordance with some embodiments of the invention can be received continuously, where training applications can update the model continuously as new data is received.

In several embodiments, model data can store various parameters, auxiliary variables, and/or weights for models. Model data in accordance with many embodiments of the invention can be updated through training on training data 930 captured on a training element 900 or can be trained remotely and updated at a training element 900. In a variety of embodiments, model data can include data for a pre-trained model that can be updated based on a new set of training data 930.

Although a specific example of a training element 900 is illustrated in this figure, any of a variety of training elements can be utilized to perform processes for training models similar to those described herein as appropriate to the requirements of specific applications in accordance with embodiments of the invention.

### C. Training Application

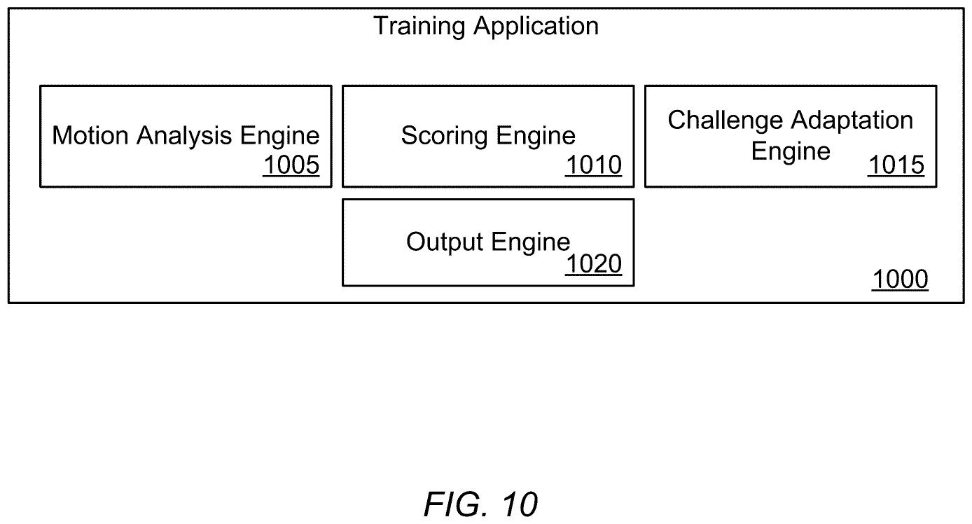

An example of a training application for training models in accordance with some embodiments of the invention is illustrated in FIG. 10. Training application 1000 includes potential selection engine 1005, loss computation engine 1010, update engine 1015, and output engine 1020. One skilled in the art will recognize that a training application may exclude certain components and/or include other components that are omitted for brevity without departing from this invention.

Potential selection engines 1005 in accordance with numerous embodiments of the invention can select potential functions to be used in training models. In numerous embodiments, potentials can be selected based on desired characteristics of the output model (e.g., generalization, sparsity, etc.).

In a number of embodiments, loss computation engines 1010 can compute losses in accordance with various methods described throughout this specification. In doing so, loss computation engines 1010 may be configured to compute loss components and regularizing components. In some embodiments, loss components can include but are not limited to constraint-enforcing loss. Constraint-enforcing losses in accordance with some embodiments of the invention can be computed based on auxiliary variables associated with each element of a training dataset. In a variety of embodiments, auxiliary variables are only used in training of the model and are not part of the output model.

Regularizing components of loss functions implemented in accordance with many embodiments of the invention can be computed by applying a potential function to weights of a model. Potential functions in accordance with a variety of embodiments of the invention can include but are not limited to various q-norm potentials, where q is a number (e.g., 1, 2, 3, 10, etc.), and/or a negative entropy potential. Regularizing components in accordance with certain embodiments of the invention can be selected to optimize closeness to the initialized model, where closeness can be computed as a Bregman divergence.

Update engines 1015 in accordance with certain embodiments of the invention can update weights of models and/or auxiliary variables throughout an optimization process. In a number of embodiments, update engines 1015 can update weights based on computed losses as described herein. Update engines 1015 in accordance with several embodiments of the invention can update auxiliary variables based on gradients for constraint-enforcing losses.

In a variety of embodiments, output engines 1020 can provide a variety of outputs to a user, including (but not limited to) weights and/or outputs for models. Outputs for a model in accordance with a variety of embodiments of the invention can include (but are not limited to) classifications, regressions, clusters, etc. In certain embodiments, outputs can include computed losses for a subset of a dataset, where another training application can update weights of a model based on losses computed at multiple different processors.

Although a specific example of a training application is illustrated in this figure, any of a variety of training applications can be utilized to perform processes for training models similar to those described herein as appropriate to the requirements of specific applications in accordance with embodiments of the invention.

While specific methods of training models are discussed above, many different methods of training models can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for training-concurrent pruning, performed by one or more processors, comprising:
obtaining a pretrained neural network model, wherein the pretrained neural network model comprises initial values for a potential function and a set of weights; and
training a neural network model based upon the pretrained neural network model and a set of training samples, wherein training the neural network model comprises, for each of a plurality of time iterations:
calculating loss for a current neural network model having a current set of weights at a current time iteration using a loss function;
updating a gradient of the potential function at the current time iteration according to a gradient of the loss;
updating an inverse mapping of the gradient of the potential function;
creating an updated neural network model including an updated set of weights for a next time iteration according to the gradient of the potential function and the inverse mapping of the gradient of the potential function, wherein the updated set of weights is obtained by pruning at least a portion of the current set of weights of the current neural network model; and
storing the updated set of weights.

2. The method of claim 1, wherein the trained neural network model is a multi-layered neural network model.

3. The method of claim 2, wherein the multi-layered neural network model is selected from the group consisting of a convolutional neural network model, a recursive neural network model, a multi-layer perceptron, and a generative adversarial network.

4. The method of claim 2, wherein the multi-layered neural network model is a large language model.

5. The method of claim 1, wherein the updated set of weights is further obtained based on at least one additional vector comprising a current set of auxiliary variables for the current neural network model.

6. The method of claim 5, wherein each sample of the set of training samples corresponds to a different auxiliary variable of the current set of auxiliary variables.

7. The method of claim 5, wherein obtaining the updated set of weights for the next time iteration comprises obtained an updated set of auxiliary variables based on the current set of weights for the current time iteration.

8. The method of claim 7, wherein each auxiliary variable of the current set of auxiliary variables is obtained based on a regularization parameter and the loss function evaluated for the current set of weights at the current time iteration.

9. The method of claim 7, wherein a regularizer mirror descent (RMD) process is used to obtain at least one selected from the group consisting of the updated set of weights; and the current set of auxiliary variables.

10. The method of claim 7, wherein iterative updates are used to obtain at least one selected from the group consisting of the updated set of weights; and the updated set of auxiliary variables.

11. A non-transitory machine-readable medium storing instructions that, when executed by a processor, are configured to cause the processor to perform operations for training-concurrent pruning, the operations comprising:
obtaining a pretrained neural network model, wherein the pretrained neural network model comprises initial values for a potential function and a set of weights; and
training a neural network model based upon the pretrained neural network model and a set of training samples, wherein training the neural network model comprises, for each of a plurality of time iterations:
calculating loss for a current neural network model having a current set of weights at a current time iteration using a loss function;
updating a gradient of the potential function at the current time iteration according to a gradient of the loss;
updating an inverse mapping of the gradient of the potential function;
creating an updated neural network model including an updated set of weights for a next time iteration according to the gradient of the potential function and the inverse mapping of the gradient of the potential function, wherein the updated set of weights is obtained by pruning at least a portion of the current set of weights of the current neural network model; and
storing the updated set of weights.

12. The non-transitory machine-readable medium of claim 11, wherein the trained neural network model is a multi-layered neural network model.

13. The non-transitory machine-readable medium of claim 12, wherein the multi-layered neural network model is selected from the group consisting of a convolutional neural network model, a recursive neural network model, a multi-layer perceptron, and a generative adversarial network.

14. The non-transitory machine-readable medium of claim 12, wherein the multi-layered neural network model is a large language model.

15. The non-transitory machine-readable medium of claim 11, wherein the updated set of weights is further obtained based on at least one additional vector comprising a current set of auxiliary variables for the current neural network model.

16. The non-transitory machine-readable medium of claim 15, wherein each sample of the set of training samples corresponds to a different auxiliary variable of the current set of auxiliary variables.

17. The non-transitory machine-readable medium of claim 15,
wherein obtaining the updated set of weights for the next time iteration comprises obtaining an updated set of auxiliary variables based on the current set of weights for the current time iteration; and
wherein each auxiliary variable of the current set of auxiliary variables is obtained based on a regularization parameter and the loss function evaluated for the current set of weights at the current time iteration.

18. The non-transitory machine-readable medium of claim 17, wherein a regularizer mirror descent (RMD) process is used to obtain at least one selected from the group consisting of the updated set of weights; and the current set of auxiliary variables.

19. The non-transitory machine-readable medium of claim 17, wherein iterative updates are used to obtain at least one selected from the group consisting of the updated set of weights; and the updated set of auxiliary variables.

20. A computing system for training-concurrent pruning, comprising:
a network interface;
a memory storing instructions; and
one or more processors configured to communicate with the network interface and the memory, the one or more processors further configured to execute the instructions to perform operations comprising:
obtaining, using the network interface, a pretrained neural network model, wherein the pretrained neural network model comprises initial values for a potential function and a set of weights; and
training a neural network model based upon the pretrained neural network model and a set of training samples, wherein training the neural network model comprises, for each of a plurality of time iterations:
calculating loss for a current neural network model having a current set of weights at a current time iteration using a loss function;
updating a gradient of the potential function at the current time iteration according to a gradient of the loss;
updating an inverse mapping of the gradient of the potential function;
creating, using the network interface an updated neural network model including an updated set of weights for a next time iteration according to the gradient of the potential function and the inverse mapping of the gradient of the potential function, wherein the updated set of weights is obtained by pruning at least a portion of the current set of weights of the current neural network model; and
storing the updated set of weights.
